(19) United States
(12) Patent Application Publication
(10) Pub. No.: US 2014/0304579 A1
(43) Pub. Date: Oct. 9, 2014

(54) Understanding Interconnected Documents

(71) Applicant: SnapDoc, Seattle, WA (US)

(72) Inventors: David Wesley Foster, Seattle, WA (US); Benjamin Anthony Leclerc, Redmond, WA (US)

(73) Assignee: SnapDoc, Seattle, WA (US)

(21) Appl. No.: 14/217,273

(22) Filed: Mar. 17, 2014

Related U.S. Application Data
(60) Provisional application No. 61/800,544, filed on Mar. 15, 2013.

(51) Int. Cl. G06F 17/22; G06F 3/0481

(52) U.S. Cl. CPC G06F 17/2235; G06F 3/0481
USPC 715/205

(57) ABSTRACT

Techniques are provided for understanding interconnected documents. A citation is identified in a first document that points to multiple portions of a second document. Hovering over a link proximate to the citation displays a multi-popup containing links to one or more of the portions of the second document. Hovering over one of the multi-popup links displays a second popup containing an associated portion of the second document. Instances of the citation, in whole or in part, are highlighted in the second popup. Within the second popup, additional citations are identified and links to associated content are generated, such that hovering over a citation contained in the second popup displays a third popup.

### CROSS-REFERENCE TO RELATED APPLICATION

This application claims the benefit of U.S. Provisional Application No. 61/800,544, filed Mar. 15, 2013.

### FIELD OF THE DISCLOSURE

The present disclosure relates generally to understanding interconnected documents, and in one embodiment to understanding issued patents, pre-grant publications, documents contained in patent prosecution histories, and other documents citing to or cited by the same.

### BACKGROUND

There are many challenges to understanding interconnected documents—i.e. one or more documents that contain internal and/or external citations. While documents are typically drafted to be read linearly from top to bottom, a reader may better understand interconnected documents by reading them non-linearly. For example, a reader may encounter a citation in a passage, look-up the cited content, and read the cited content before continuing the passage. Often, the cited content will itself contain a citation that the reader desires understand, triggering another look-up. In this way, the reader is repeatedly taking time to perform look-ups, diverting attention from and thus hindering understanding of the initial passage.

Patents and related documents typically contain citations. Patent practitioners and examiners spend much of their time answering the question “what does this cited content mean”? For example, in rejecting a claim element, an office action may cite to “Jones, Fig. 13: 18”, the content of which a practitioner must understand in order to determine the validity of the rejection. To understand the content of “Jones, Fig. 13: 18”, the practitioner must first parse the citation, i.e. read and identify that it is figure 13, reference identifier (RI) 18 of Jones that is being cited to. The practitioner must then acquire a copy of the Jones reference, usually from an online repository. Then the practitioner must locate FIG. 13 within the Jones reference, either by flipping through pages of a printout or scrolling/searching an electronic copy, and then visually scan figure 13 to locate RI 18. Then, upon understanding the cited portion of Jones, the practitioner returns focus to the office action to determine if the rejection is valid. Often the practitioner will glance back and forth between RI 18 and the rejection to determine if the rejection is valid.

However, merely locating RI 18 in Fig. 13 may not be sufficient to determine if it teaches the rejected element. The practitioner may want to read a written description of RI 18 to better understand it, necessitating a search of Jones' specification for RI 18.

Moreover, to better understand RI 18, the practitioner may want to understand RI 20, also contained in Fig. 13, triggering the practitioner to locate other references to RI 20 throughout the specification and drawing figures before returning to understand RI 18. Understanding RI 20 may further require understanding RIs 22 and 24. In this way, practitioners often recursively navigate through documents in a non-linear fashion, locating cited content and understanding it before returning to the passage/drawing figure containing the citation.

Each iteration of parse/acquire/locate/return takes time and mental capacity, and ultimately makes it more difficult determine whether the rejection is proper. Moreover, as the practitioner is performing a series of parse/acquire/locate/returns, he or she may take additional time to periodically glance back at the rejection in question. Depending on the granularity of the rejection, the number of claims, and the complexity of the reference, practitioners may parse/acquire/locate/return hundreds of times or more while responding to an office action.

The aforementioned problems have been addressed in part by Zellner, U.S. Pat. No. 7,444,589, which is hereby incorporated by reference. This and all other referenced patents and applications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. Zellner discloses analyzing electronic content to identify citations to external references (3:5-8) and inserting electronic associations corresponding to the external reference into the electronic content (4:51-54). However, an electronic association to the external reference only mitigates a small fraction of the parse/acquire/locate/return iterations described above. For example, Zellner does not create links out of reference identifiers. Moreover, even when Zellner does eliminate the need to parse and acquire, Zellner's electronic associations appear to navigate away from the office action, causing the practitioner to take their focus away from the office action. Thus, Zellner doesn't appear to eliminate most of a practitioner's parse/acquire/locate/return iterations.

The aforementioned problems have also been addressed in part by Henry, U.S. Publication 2009/0228777, which is hereby incorporated by reference. Henry discusses correlating elements of the detailed description, claim terms, and portions of the drawing figures ([0228], [0292]). In one embodiment of Henry, a user may identify a correlated element, either by selecting from linking display 2530 or by double clicking on a claim element or spec element. Henry will then highlight and identify other instances of that element in the document ([0271], [0292], FIG. 23). Once highlighted, a user is enabled to jump from instance to instance of the selected element using “previous” and “next” buttons ([0296], FIG. 23). However, while Henry's correlated elements and figures may enable cycling through other instances of a particular element, and while Henry may enable highlighting other instances of a particular element, Henry doesn't appear to provide a mechanism to “return” to a previous location in the patent, other than cycling the other way. As such, Henry's users must manually avoid losing their place in the document.

The aforementioned problems have also been addressed in part by Lin, U.S. Publication 2006/0271577, which is hereby incorporated by reference. Lin discusses associating graphic elements and textual descriptions based on a shared “alpha-number designation” ([0026]). Lin also discusses enabling a user to double click an alpha-numeral designation of a drawing figure, causing a textual-description box to be displayed (FIG. 4B and [0029]). However, even if Lin helps located content by displaying textual descriptions in response to a double click of a “alpha-number”, Lin still leaves the practitioner to manually navigate between documents.

Thus, a continued need exists for techniques for understanding interconnected documents by reducing or eliminating the number of parse/acquire/locate/return iterations while minimizing the time spent glancing between documents on a screen.

Another challenge to understanding interconnected documents is that concepts may be discussed in many disparate locations throughout the document. Often, a thorough reading of these documents requires the practitioner/examiner to scan tens or hundreds of pages of documents to find a comparatively small amount of relevant text describing the concept. Such scanning is prudent, however, as small amounts of text can have large legal implications.

For example, a practitioner will often want to state with certainty that the rejected element does not read on RI 18. Thus, the practitioner will search and scan for all written descriptions of and figures containing RI 18 to know the complete extent of RI 18's meaning.

Solutions to these and other problems are discussed below

### BRIEF DESCRIPTION OF THE DRAWINGS

Embodiments of methods and systems in accordance with the teachings of the present disclosure are described in detail below with reference to the following drawings.

FIG. 1 depicts a page 100 of an Office Action processed to include links to related information.

FIG. 2 depicts a popup containing col. 6 lines 1-20 of Kirmse triggered by activating the “col. 6 lines 1-20” link.

FIG. 3 depicts a cascading popup containing figure 13 triggered by activating the “col. 6 lines 1-20” link and the reference identifier “12” link.

FIG. 4 depicts a “multi-popup” containing links to each of claims 1-20, triggered by activating the “Claims 1-20” link.

FIG. 5 depicts the multi-popup and a popup containing claim 1, both triggered by activating the “Claims 1-20” link.

FIG. 6 depicts a popup containing a previous version of claim 1 triggered by activating the “Claims 1-20” link, the “1” link, and the “Currently Amended” link.

FIG. 7 depicts a popup containing claim 3 triggered by activating the “Claims 1-20” link and the “3” link.

FIG. 8 depicts a popup containing claim 1, from which claim 3 depends, triggered by activating the “Claims 1-20” link, the “3” link, and the “Claim 1” link.

FIG. 9 depicts a popup containing a previously entered version of claim 1 triggered by activating the “Claims 1-20” link, the “3” link, the (obscured) “Claim 1” link, and the “Currently amended” link.

FIG. 10 depicts a popup containing the cover page of the Jones reference, triggered by activating the “Kirmse” link.

FIG. 11 depicts a link hierarchy representing documents extracted from a file wrapper and references (e.g. Kirmse) cited in the office action.

FIG. 12 depicts the link hierarchy with an expanded 102(e) rejection node that contains links to each claim rejected under 35 USC 102(e).

FIG. 13 depicts the rejection of claim 4, triggered by activating the “Claim 4” link in the link ark hierarchy.

FIG. 14 depicts the link hierarchy as viewed from the Kirmse reference.

FIG. 15 depicts a drawing FIG. 300, including reference identifier links.

FIG. 16 depicts a popup containing a paragraph of text that contains reference identifier 26, triggered by activating the reference identifier 26 link.

FIG. 17 depicts a multi-popup to five portions of text that contain reference identifier 16, where one of the five popups has been chosen for display in a popup, and where each instance of reference identifier 16 is highlighted.

FIG. 18 depicts popup “3”, highlighting instances of reference identifier 16.

FIG. 19 depicts a portion of a written description 400.

FIG. 20 depicts a multi-popup 2002 linking to three figures (1, 12, and 13) that contain reference identifier 16, as well as a popup 2006 containing FIG. 12 triggered by activating link 2004.

FIG. 21 depicts a popup containing FIG. 14 that highlights reference-index 306 and is triggered by activating the “306” link.

FIG. 22 depicts a close-up of the popup 2102 containing FIG. 14.

FIG. 23 depicts a flow chart describing steps to display a multi-popup.

FIG. 24 depicts a flow chart describing steps to display a cascading popup.

### DETAILED DESCRIPTION

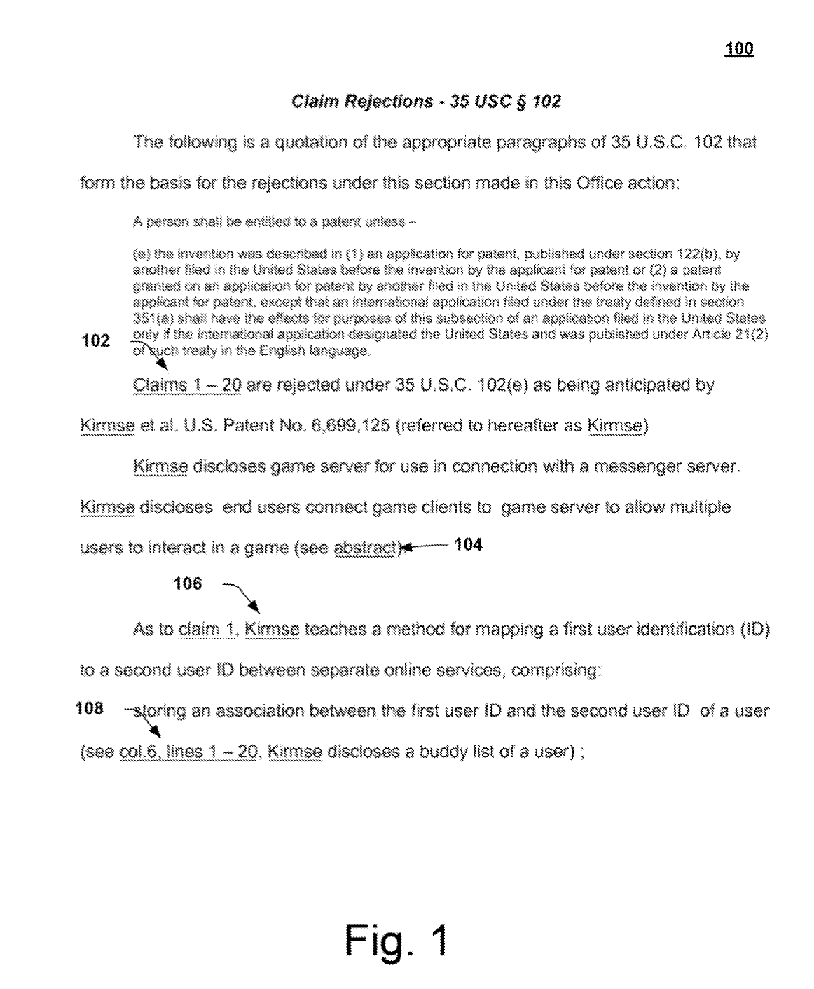

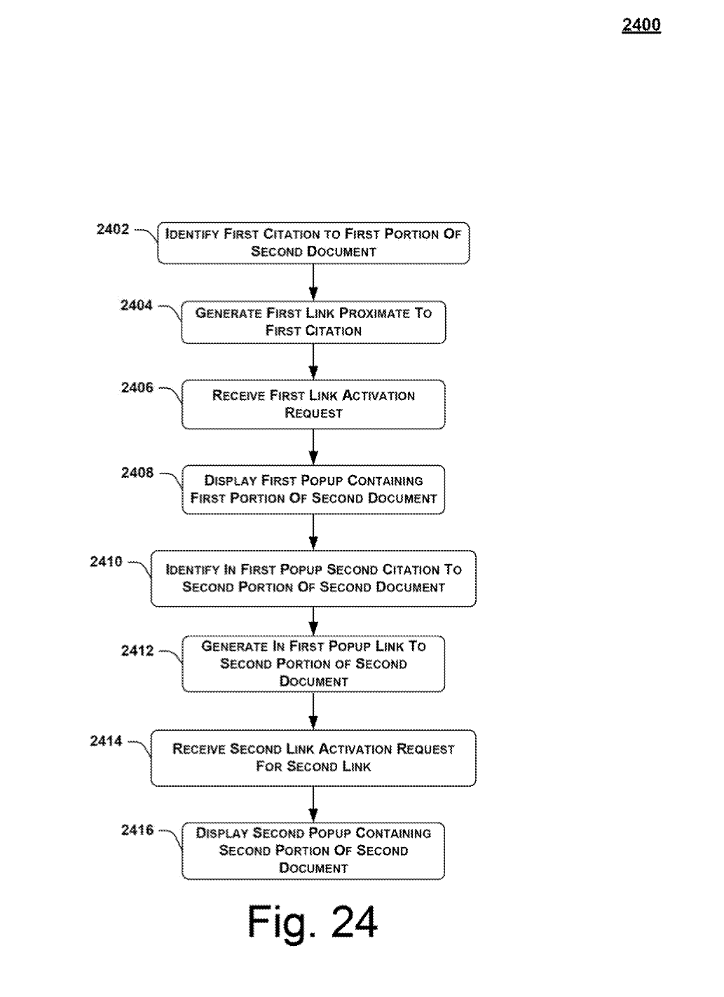

Embodiments for understanding interconnected documents are described herein. Many specific details of certain embodiments are set forth in the following description and in FIGS. 1-24 to provide a thorough understanding of such embodiments. One skilled in the art will understand, however, that the invention may have additional embodiments, or that alternate embodiments may be practiced without several of the details described in the following description.

The claimed embodiments may be implemented on a device including one or more processing units and a non-transitory computer readable media. By way of example, and not limitation, non-transitory computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired information and which can accessed by the one or more processing units.

FIG. 1 depicts a page 100 of an Office Action processed to include links to related information. A link 102 under text “Claims 1-20”, a link 104 under the text “abstract”, a link 106 under the text “Kirmse”, and a link 108 under the text “col. 6, lines 1-20” all indicate additional information is available to the user by activating the link.

Each link is indicated by an underline, although other indications such as highlights, shading, boxing, or the like are similarly contemplated. Links may indicate the type of destination a citation points to by color coding, selective bolding, shading depth, or the like. For example, citations to prior art references may be colored in green, while citations to file history documents may be colored blue.

Identifying Citations

The text associated with links 102, 104, 106, and 108 are examples of citations that are identified in a parsing procedure. Generally speaking, a citation is a reference to another piece of content—e.g. a whole document or a section of a document, where a document may be any kind of publication, web page, blog, or the like. Citations may be intra document—the destination is within the same document—or inter document—pointing to all or a section of a different document. The content a citation points to is defined as a “target” or “destination”. A citation is not limited to referring to a single destination. For example, an instance of a reference identifier implicitly cites to some or all of the other instances of that reference identifier.

Some citations are explicit—meaning the destination is written out, e.g. “col. 6, lines 1-20” or “claim 1”. Some explicit citations—defined herein as layout citations—refer to a particular location in a particular document in terms of the layout of that document, such as one or more combinations of page, column, and line number. Other explicit references—defined herein as logical citations—refer to logical constructs in a document, such as claim 1 or paragraph [0003]. The location of logical constructs are defined without reference to page layout—and are often in terms of an ordinal list, although using row & column to identify a cell in a table, or any other logical addressing technique, is similarly contemplated. Still other explicit references—defined herein as non-definitional references—refer to a particular part, element, or concept used throughout the document but which does not have a primary definition located in the document. Non-definitional references are indicated in the document by an identifier. In patents these identifiers are reference identifiers (RI), such as RI 18 discussed above.

Other citations may be implicit—defined as citations which include numbers, such as column or line number, but in which the content itself is the citation. Examples of implicit citations include acronyms, words, and phrases that are defined elsewhere in the document. Other implicit citations are claim terms that implicitly cite to their antecedent term, that implicitly cite to textually similar elements in the detailed description, and even that implicitly cite to drawing figure elements. A claim term is associated with drawing figures by first associating with elements in the detailed description that are textually similar to the claim term, then determining the reference identifiers associated with these elements, and finally by searching for drawing figures/drawing elements associated with the reference identifier.

While patents and related documents (e.g. documents contained in file histories including office actions, information disclosure statements, etc.), assignments, and the like, will be discussed throughout this application, the same techniques apply equally to other types of documents such as case law, product manuals, medical records, tax forms, engineering drawings, contracts, academic writings, software code, and the like, or any combination thereof. It is understood that each of these other types of documents has their own types of citations, which may overlap in part or not at all with the types of citations contained in patents and related documents. However, the same general techniques may be applied to these other document types to achieve the same inventive effect.

In one embodiment, the citation parsing procedure analyzes a text-based representation of the page 100. Sometimes, Optical Character Recognition (ORC) must be performed on an image based version of page 100 to produce the text-based representation. The parsing procedure identifies citations in the text-based representation of page 100, and generates links 102, 104, 106, and 108 based on the identified citations. Link 102 refers to claims 1-20 of the instant application. Link 104 refers to the abstract of the Kirmse reference. Link 106 refers to the cover page of the Kirmse reference, and Link 108 refers to the text contained in column 6 lines 1-20 of the Kirmse reference.

In general, string parsing techniques such as string templates, recursive descent parsers, regular expressions, or the like may be used to extract a citation from the text-based representation of the page. One type of citation identified in the text-based representation of page 100 are cited reference citations (references to prior art). FIG. 1 depicts only one cited reference—Kirmse, but additional references are similarly contemplated and would be processed similarly. While page 100 is a page taken from an office action, the same techniques of cited reference identification apply to any type of document, including practitioner arguments, legal briefs, patents, patent publications, source code, or any other document type indicated above.

In the case of identifying cited references, patent and pre-grant publication numbers (both domestic and foreign) are identified, as are Universal Resource Identifiers (URIs), books, periodicals, or any other type of publication typically cited to in an office action. In addition to identifying the number (or other identifier) of the cited reference, an inventor's name proximate to the number may be extracted—typically from text adjacent to the number. Also, a publication date, kind code, or other identifying information may similarly be extracted. For example, the string “as being anticipated by Kirmse et al. U.S. Pat. No. 6,699,125 (referred to hereafter as Kirmse)” is parsed to extract the inventor name (Kirmse) and the patent number (U.S. Pat. No. 6,699,125). Often, the inventor's name is used as short-hand to refer to the cited reference. However, other short-hands are sometimes used, and may be identified by patterns of text proximate to the citation such as “referred to hereafter as K” or “hereafter K” or simply “(K)”.

In one embodiment, the inventor name is confirmed to be associated with the patent/pre-grant publication number (or other publication identifier) by consulting a database of patent information. In another embodiment, the accuracy of the citation is confirmed by parsing a “references cited” document included with the office action and determining whether the citation identified in the office action is also included in the “references cited” document.

In one embodiment, the text to be searched is narrowed to claim rejections—e.g. a section beginning with the heading “Claim Rejections—35 USC 102(103)”—as claim rejections typically include prior art citations. One technique to identify a claim rejection is to perform a string comparison against known rejection boilerplate. For example, the text “The following is a quotation of the appropriate paragraphs of 35 U.S.C. 102 that form the basis for the rejections under this section” identifies the beginning of a block of text containing a rejection. The end of the block may be demarcated by the beginning of another rejection, the beginning of another section of the office action, or the end of the office action. Once the rejection has been identified, techniques discussed above can be used to extract the citations.

If a short-hand for a cited reference has been identified, the text-based representation of the office action may be scanned for other instances of the short-hand. Alternatively, if a claim rejection containing the short-hand has been identified, the claim rejection may be scanned for other instances of the short-hand. In one embodiment, an instance of the reference's short-hand is itself the basis of a link, defined herein as a whole document link, such as link 106 (“Kirmse”). A user may activate a whole document link to view additional information about the cited reference, such as an image of the cited reference's cover page. When a citation is identified, but a short-hand for the cited reference has not been identified, a whole document link is generated for the citation itself (e.g. U.S. Pat. No. 6,699,125).

Citations to a section of prior art, such as “col. 6, lines 1-20”, on which link 108 is based, are also identified with a string template, recursive descent parser, regular expression, or other text parsing technique. A “section citation” is defined as a citation that refers to a portion of a document. Both layout citations and logical citations as defined above tend to be section citations. One challenge to extracting section citations is identifying which of a plurality of references the section citation is associated with. In some cases, only one reference is cited throughout the office action, and so by default each section citation is associated with it. When more than one reference is cited by the office action, it is useful to first break the document into blocks of text that only cited to a particular reference, such that any section citations identified within the narrowed blocks are associated with the single reference. For example, even if many references are cited throughout an office action, a “102 rejection” block typically cites to a single reference. The beginning of a “102 rejection” block may be identified by boilerplate such as “are rejected under 35 U.S.C. 102(e) as being . . . ” Any citations identified after the beginning of the 102 rejection but before the start of the next rejection (or before the end of the office action), are treated as if they are associated with the single reference cited in that 102 rejection.

For example, if claim 1 is 102 rejected over Kirmse, but claim 2 is 102 rejected over Jones, then any section citation identified between the beginning of the rejection of claim 1 and the beginning of the rejection of claim 2 is associated with the Kirmse reference, while any section citation identified after the beginning of the rejection of claim 2 (but before the end of the rejection of claim 2) is associated with the Jones reference.

Another technique to identify which reference is associated with a section citation is by identifying a reference's short-hand (e.g. inventor name) proximate to the section citation. For example, “see col. 6, lines 1-20, Kirmse” is identified as column 6 lines 1-20 of the Kirmse reference, based on the proximity (e.g. adjacency) of the section citation (“col. 6, lines 1-20”) to the reference's short-hand (“Kirmse”). The reference's short-hand may similarly come before the section citation, e.g. “see Kirmse col. 6, lines 1-20”, or the section citation may be one of a plurality of section citations associated with the reference short-hand, e.g. “see Kirmse col. I lines 3-5 and col. 6 lines 1-20”.

Office actions will often demarcate citations to references from other text using parentheses or some other grouping identifier. For example, “(see col. 6, lines 1-20, Kirmse . . . )” is contained in a parenthetical, and as such “col. 6, lines 1-20” is associated with the “Kirmse” reference. Thus, in one embodiment, section citations contained in a parenthetical are associated with a cited reference. However, section citations that are not contained in a parenthetical, such as “claim 1”, are commonly associated with the instant application. Thus, in one embodiment, section citations identified outside of parentheticals associated with the instant application. For example, the text “As to claim 1, Kirmse” is not contained within a parenthetical. Thus, even though “Kirmse” is proximate to “claim 1”, “claim 1” is associated with the instant application, not the Kirmse reference.

Selective Text Coloring

Another challenge to understanding documents generated during the patent prosecution process, including office actions and office action responses, is interpreting text that contains a tight intertwine of inline quotes, citations, and argument. For example, a typical claim rejection will quote elements of the claim at issue, between which citations, quotations from references, quotations from the application, quotations from previous office actions/responses, and examiner argument all appear. As a result, identifying what text comes from which documents can be challenging. A similar issue exists understanding office action responses.

In one embodiment, text contained in an office action (or office action response, or any other document type) is analyzed. In one embodiment, text matching algorithms are used to identify quotes of a claim, quotes from the application's written description, quotes from cited references, and quotes of the practitioner/examiner who authored a previous response/office action. By default, text that remains is interpreted as examiner argument. In one embodiment, text contained within parentheticals is typically a citation, a quote from a reference, or examiner argument, and so these sources may be searched first to find a match—but other sources of the text may also be searched.

Then, in one embodiment, text is color coded based on the source of each piece of text. For example, claim quotations may be black, examiner argument red, quotes from the reference purple, quotes from the specification blue, etc. This color coding scheme may or may not conform to the color coding scheme used for links. For example, if a link to a cited reference is colored blue, then quotes from a cited reference may be colored with the same shade of blue. Alternatively, each reference may be assigned a unique color/shade, such that citations to and quotations from the same reference are readily identifiable. Optionally, font size or accent (e.g. bold, italics) may also be changed based on the source of the text.

In one embodiment, the office action being processed is a black and white image. As such, color coding is performed by identifying, from the text-based (e.g. OCRed) representation of the office action, the text to be colored. Then, a bounding box around the text is determined. The bounding box defines the region(s) of the image that contain the text to be colored. Next, the black and white image is copied into a color-enabled image, and all black pixels contained within the bounding box are changed to the desired color.

Other types of documents may also be color coded, such as the written description of a patent. In one embodiment, boilerplate text, e.g. text that is unchanged or little changed between patents, is identified and color coded. In one embodiment, potential boilerplate is identified by searching patents and publications filed by the same attorney, filed by the same law firm, and/or assigned to the same entity, for common pieces of text. In one embodiment, other patents in the family of the instant patent are excluded from the search, as they may contain blocks of text in common that are substantive. Patents from the same attorney, law firm, or assignee are searched because these entities are likely to re-use text in their patents. The instant patent is then searched for the identified potential boilerplate. In one embodiment, boilerplate found in the instant patent is greyed out, collapsed, or otherwise minimized, thereby allowing the reader to focus on more substantive text.

In another embodiment, patentese, such as “in one embodiment”, “additionally or alternatively”, and the like, is identified in a patent application and greyed out.

Determining if a Reference is Proper Prior Art

A common problem faced by patent practitioners is identifying when a cited reference is not proper prior art. There are a number of factors used to determine whether a reference is proper prior art or not, including the filing date of the instant application, the priority date of the reference, the language of the reference, whether the reference is a patent publication, etc.

In one embodiment, for each reference cited in an office action, such as the Kirmse reference of page 100, a priority date of the reference is compared against a priority date of the application. Any number of means are usable to determine the priority date of a reference, including online databases, a publication of the reference, and the like. If the priority date of the reference does not antedate the priority date of the application, the practitioner is alerted by highlighting the rejection. In one embodiment, a template response to the improper prior art is generated and optionally inserted into an office action response.

Sometimes, an examiner will cite to a reference that has a priority date before the priority date of the instant application, but a filing date that is after the priority date of the instant application. Sometimes there is a difference in subject matter between the cited reference and the document that actually antedates the instant application (the document the cited reference claims priority to). For example, if the cited reference claims priority to a provisional application, or is a continuation in part application, some of the subject matter disclosed in the cited reference may not be proper prior art. For example, if a rejection cites to Smith [0234], but the priority document smith relies upon ends at [0100], it is possible that Smith [0234] was not disclosed before the instant application's filing date, and as such is not proper prior art.

So, in one embodiment, a comparison is made between a cited reference and a priority document of the cited reference. In one embodiment a list of words found in the reference but not the priority document is generated. If the cited portion of the reference includes one of these words, the practitioner is alerted, as it's possible the cited portion is not proper prior art. In another embodiment, traditional text search and diff algorithms can be used to identify support for the cited paragraph in the priority document.

Identifying Copy and Paste Rejections/Arguments

Often, as a patent application is prosecuted, claim rejections, such as those depicted in FIG. 1, are re-used from office action to office action. Practitioner arguments similarly are re-used from response to response. This typically happens with dependent claims, which are rejected initially but then not revisited. Also, one or more elements of a claim may go un-amended, and the corresponding portions of that claim's rejection go unchanged, even though other elements of the same claim are amended and argued.

However, it is not uncommon for examiners and practitioners to make small changes to these arguments, often in ways that are difficult to perceive. For example, a practitioner may delete one of 20 members of a markush group. Or, an examiner may copy and paste an argument while replacing one citation among many, or replacing one secondary reference with another.

A common source of frustration for patent practitioners and patent examiners is diligently reviewing arguments to make sure they haven't changed from the last rejection/response. Thus, in one embodiment, text analysis is performed to reduce the amount of text scanning of performed by practitioners and examiners just to verify arguments haven't changed.

Thus, in one embodiment, a text analysis is performed between the instant office action and a previous office action (the same analysis can be performed on successive practitioner arguments, or any other document type). The text analysis identifies arguments that are unchanged from the previous office action. In one embodiment, if an argument is un-changed, the rejection of that claim, including the un-changed argument, is greyed out, collapsed, or otherwise obscured. If arguments associated with one or more elements of a claim are unchanged, these arguments may be greyed out, while the arguments that have changed are un-altered or even highlighted as having changed.

Identifying Outdated Arguments

While some arguments may be intentionally un-changed, sometimes a claim has been amended but the subsequent rejection of that claim is un-changed. This typically indicates a mistake or omission on the part of the patent examiner. Thus, in another embodiment, text analysis may be used to identify claim rejections that do not address current versions of claim. In one embodiment, the rejection of a claim that was previously amended is compared against the previous rejection of that claim. If the claim was amended, but the rejection is un-changed, the practitioner is alerted by highlighting the rejection in the office action.

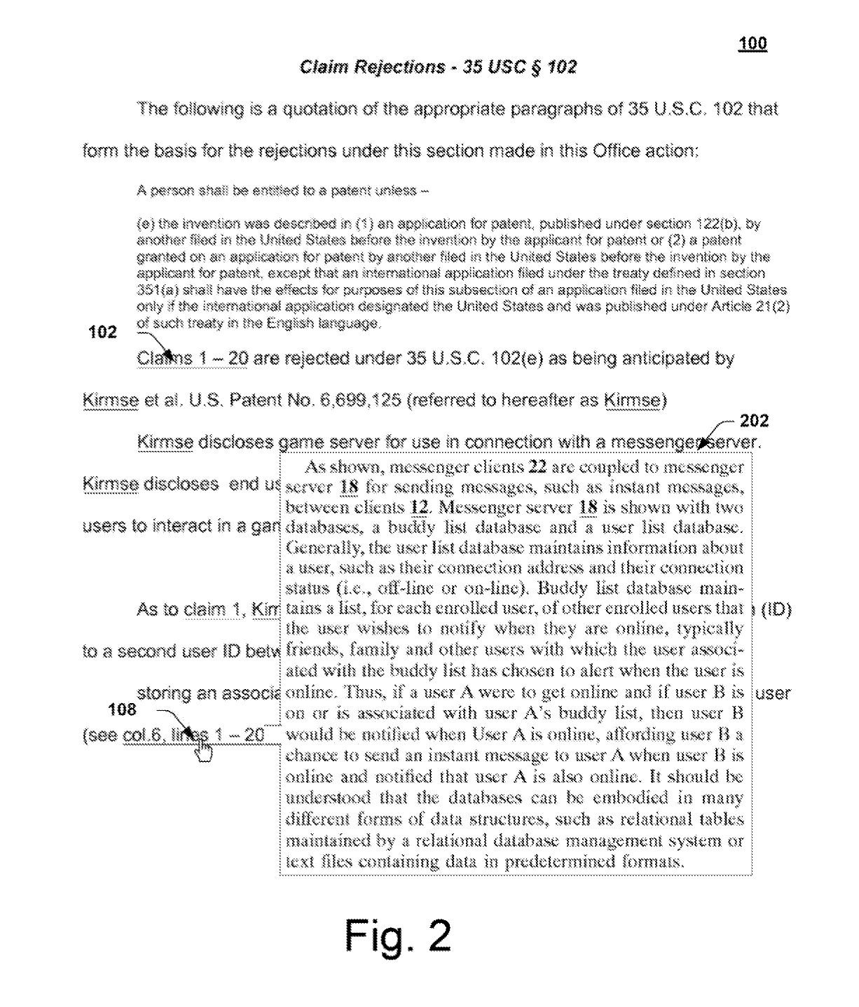

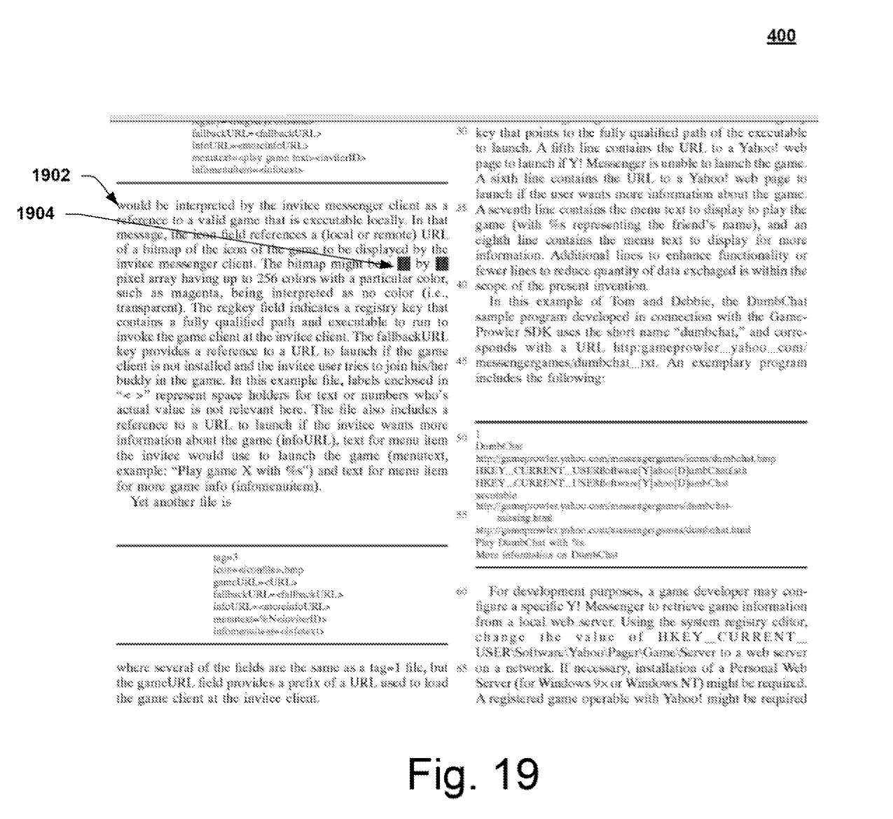

FIG. 2 depicts a popup 202 containing col. 6 lines 1-20 of Kirmse, triggered by activating link 108. Popups can be triggered by pointer “hover-overs” or “clicks”, whether caused by a mouse, trackball, or other pointing device. Popups may also be triggered by a keyboard hot-key press, touch screen press, eye tracking, voice command, or the like. Similarly, popups can be dismissed by moving the pointer outside the boundary of the popup, by “clicking” outside the boundary of the popup, by a keyboard hot-key press, by a touch screen press outside of the boundary, by eye tracking, by voice command, or the like. Throughout this document, “hover-over” is used to describe any of the above described methods of activating a link to trigger a popup. “clicking” is used throughout to describe any of the above described methods of activating a link to open the cited document in a new window, navigate to the cited content, and highlight the cited content (see FIG. 19).

In one embodiment, the popup contains content, including cropped image content, extracted text content, or a combination thereof, extracted from the destination document. However, the popup may contain information drawn from any source, such as a dictionary, website, or the like.

In one embodiment, popup 202 is scrollable, typically vertically, such as by clicking and dragging a scroll bar or by rolling a scroll wheel on a mouse. In one embodiment, scrolling popup 202 reveals text above or below the cited text, depending on the direction of the scroll.

In one embodiment, scrolling popup window 202 causes ranges of text that are split across multiple columns or pages to appear as a continuous stream of text. For example, if “scroll-up” were activated, and if col. 5 line 67 of Kirmse contained the text “A peck of pickled peppers.”, the top line of text of popup window 202 would contain “A peck of pickled peppers”, while the bottom line of text of popup window 202 would no longer be visible. In this way, a user may navigate the content of a multi-column document without obscuring the underlying page 100 with a second column.

Popup position is chosen with the goals of minimizing the on-screen distance between the citation and the popup and allowing content from the underlying document to be displayed concurrent with the popup content (i.e. not occluded by the pop-up). In this way, a user may quickly read the pop-up contents without losing their place in the underlying document. When discussing popup position herein, a three dimensional positioning system is used, where the “left” and “right” determine the position in the x-axis (horizontal), “up” and “down” determine the position in the y-axis (vertical), and “front” and “back” denote position in the z-axis (coming out of the page). When the dimension being described may be ambiguous, parentheticals such as (y-axis) or (z-axis) are used to clarify.

Towards these ends, in one embodiment popup 202 is positioned based on the type of document the citation is contained in, the type of content the citation is proximate to, the type of document cited to, and/or the type of content cited to. In one embodiment, when a citation is in support of an argument, the popup is positioned below (y-axis) the citation. In this way, the user may view the argument and the pop-up contents at the same time, without one occluding the other. One example of a citation in support of an argument is a citation to a reference contained in an office action, where the citation is proximate to a rejection. By positioning the popup below (y-axis) the citation, the user is enabled to view the text of the rejection and the cited content at the same time. By positioning the top (y-axis) of the popup close to the bottom (y-axis) of the citation—e.g. closer than the width of a line of text—a user is enabled to view the cited content without losing their place, or train of thought, in the rejection.

In another embodiment, popups may be positioned above (y-axis) a citation when it is determined that the citation appears at the beginning of a paragraph. Often, a citation at the beginning of a paragraph is a citation to the subject of that paragraph. If so, it is advantageous to view the subject of the paragraph and the paragraph itself concurrently. For example, in this embodiment, link 102 to claims 1-20 may trigger a popup positioned above (e.g. within the width of a row of text) the text “Claims 1-20”, such that the bottom of the popup lies above the top of link 102.

The content pointed to by the citation can also determine positioning of the popup. For example, drawing figures may, by convention, be displayed above a citation, while text blocks may be displayed below it.

Inferring Popup Content Indirectly

As described above, in one embodiment, a popup is triggered when a user hovers over, touches, or otherwise activates a link. However, another embodiment is contemplated which infers what the user is interested in knowing more of based on the location of the mouse pointer in a piece of content—without the user hovering over a link. Instead, in one embodiment, a reference identifier is chosen based on the location of the mouse pointer. Then, of the pieces of content (e.g. paragraphs, drawing figures) that contain the chosen reference identifier, one is selected for display. Since inferred popup content is not triggered by a link, the inferred popup content is displayed in a “definition window”, which is typically does not scroll with the document (i.e. it is anchored to the application window, as opposed to being embedded in the content of the document), nor is its location bound to the location of a particular reference identifier.

In one embodiment, when the source content is a block of text (e.g. a page, a paragraph, a line, etc.), a reference identifier with the highest “density”, given the current mouse pointer position, is chosen. Density may be calculated, for example, by summing the square-root of the distance between the mouse pointer and all instances of a reference identifier in the block of text. Distance may be a Cartesian distance on the page or a letter separation distance, i.e. how many letters are between the cursor and a given reference identifier.

A reference identifier may also be chosen when the source content is a drawing figure. In one embodiment, lead lines may be analyzed to determine what reference identifier(s) are associated with the portion of the drawing the mouse pointer is currently hovering over. For example, if the user is viewing a flow chart, the reference identifier associated with a block of the flow chart may be chosen by identifying the block the mouse pointer is contained in, identifying the lead line pointing to the block, and then identifying the reference identifier at the other end of the lead line.

In another embodiment, when a reference identifier is located within a drawing figure element (i.e. without a lead line), the reference identifier is determined by identifying the drawing figure element currently enclosing the mouse pointer, then identifying the reference identifier also within the drawing element (typically reference identifiers within a surface are underlined).

Regardless how the reference identifier is chosen, content containing the reference identifier is then selected for display in the definition window based on a prioritization algorithm. Both text from the written description and drawing figures containing the reference identifier can be displayed in the definition window. A number of prioritization techniques discussed below are contemplated, any of which may be applied alone or in combination.

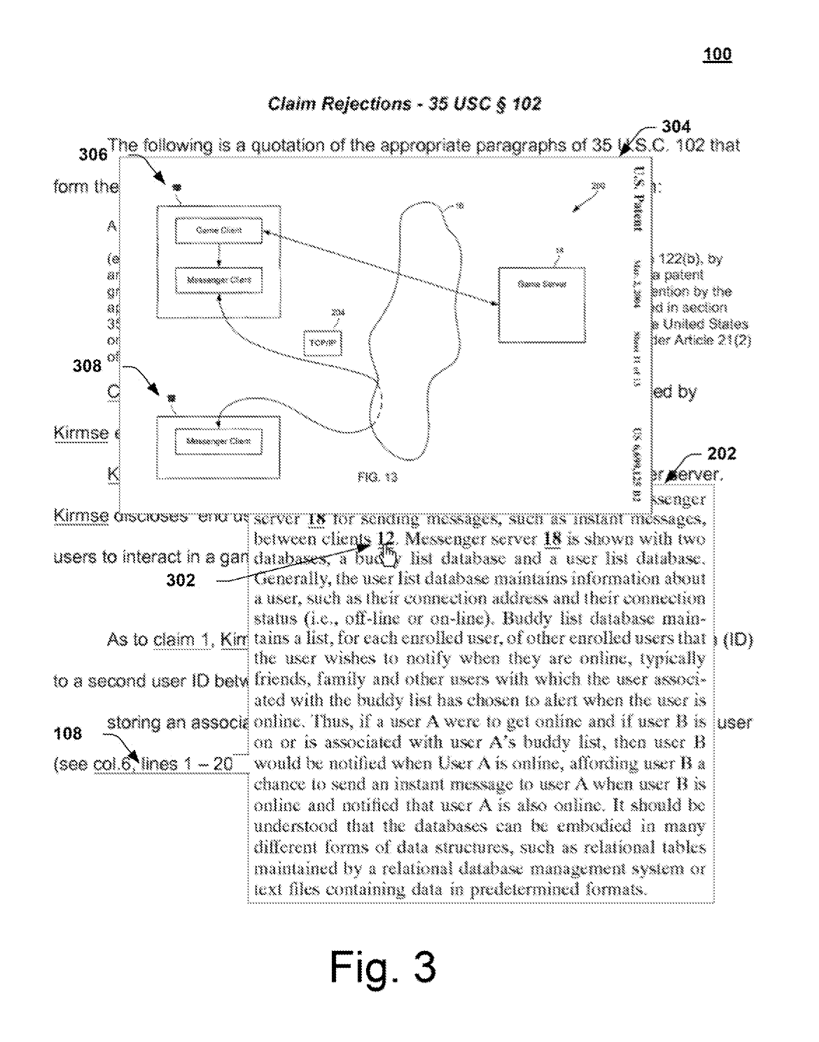

In one embodiment, priority is given to a first piece of content found in the document that contains the chosen reference identifier. For example, if FIGS. 3, 8, and 9 include reference identifier 12, this method would prioritize FIG. 3, as it appears first in the document.

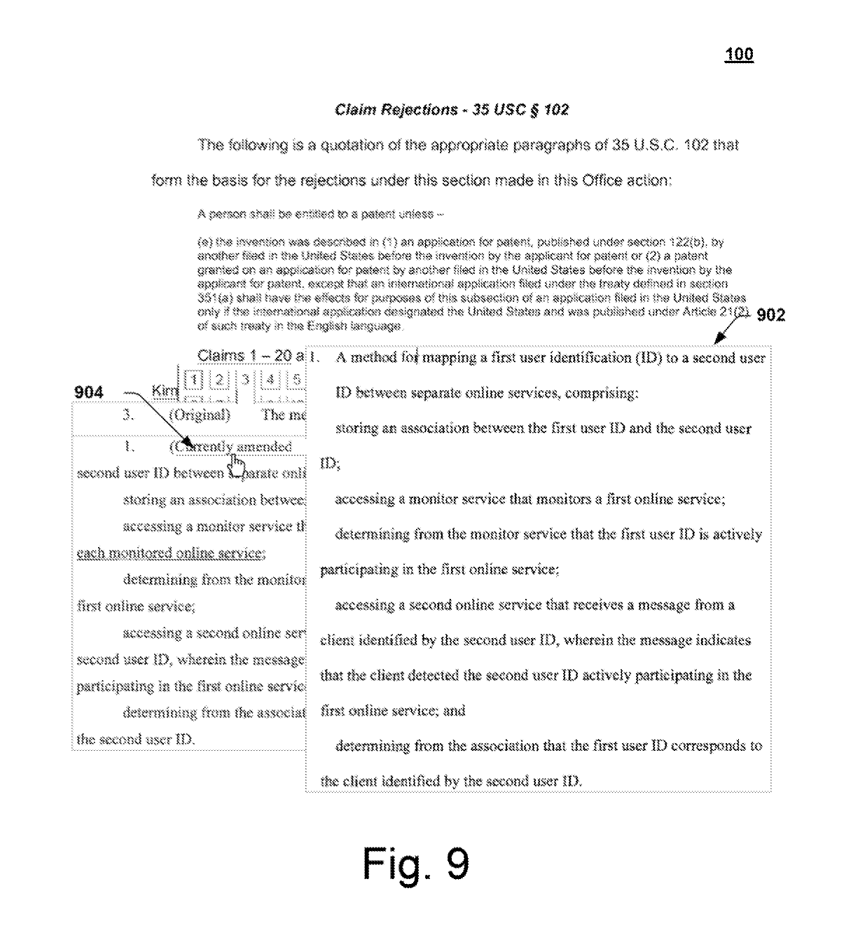

In another embodiment, a piece of content may be prioritized based on the number of times the reference identifier appears within a given piece of the content. For example, if FIG. 3 has one instance of reference identifier 12, but FIG. 9 contains five instances, this method prioritizes FIG. 9.

In another embodiment, priority is determined based on a relative number of occurrences of the reference identifier—that is, the number of occurrences of the reference identifier compared to the total number of occurrences of other reference identifiers in a given piece of content. Continuing the example, if FIG. 3 contains one instance of reference identifier “12”, but it is the only reference identifier in FIG. 3 (i.e. 100% of reference identifiers are “12”), while FIG. 9 contains 50 reference identifiers (i.e. 10% of the reference identifiers are “12”), FIG. 3 may be prioritized even though FIG. 9 has a larger absolute number of instances.

In another embodiment, priority is determined based on whether a piece of content contains an acronym definition associated with the reference identifier. For example, if the citation is reference identifier 102, but throughout the cited reference it is referred to as “CPU 102”, priority can be given to the paragraph(s) that defines “CPU” as “Central Processing Unit 102”.

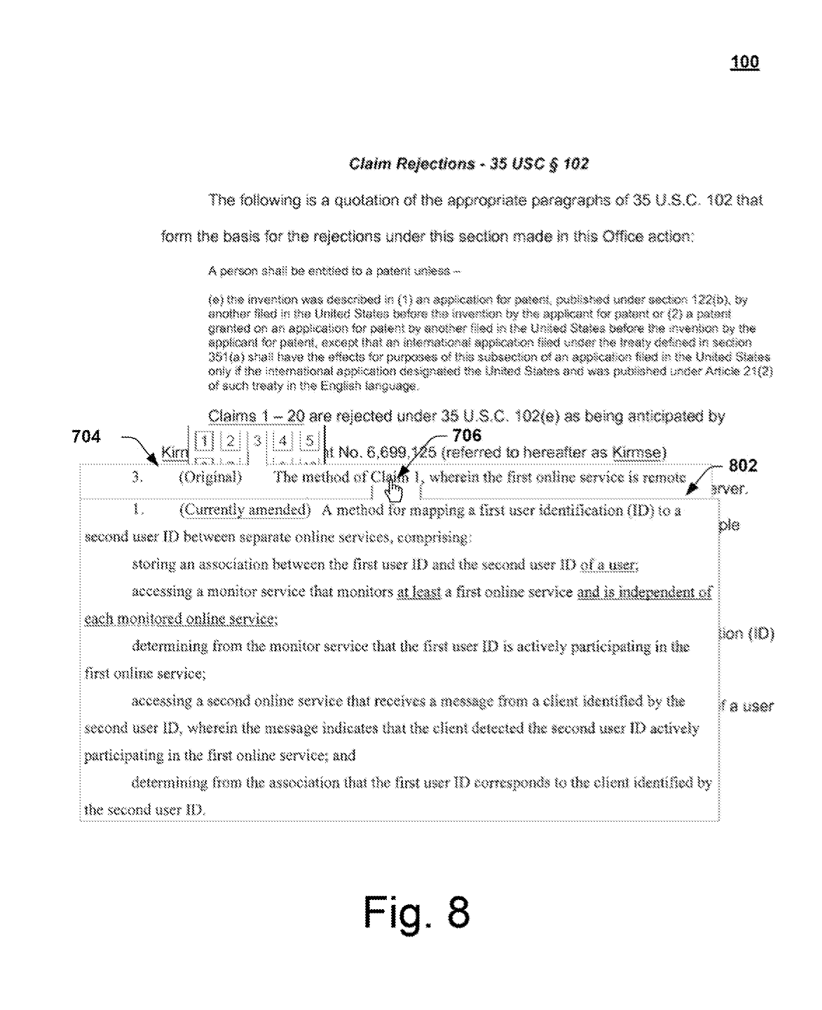

In another embodiment, a piece of content may be prioritized based on if it contains other reference identifiers that are also found proximate to the citation. For example, if reference identifier 18 is located in the same block of text, e.g. on the same line, as reference identifier “12”, and FIG. 8 (but not FIGS. 3 and 9) also contains reference identifier 18, FIG. 8 would be prioritized by this method. If multiple pieces of content contained reference identifier 18, then priority is given to the content with more instances of reference identifier 18. Other types of blocks of text are similarly contemplated. In one embodiment, the other reference identifier may be the next (or previous) reference identifier as would be read by a user, relative to the position of the mouse cursor, whether or not it is on the same line of text. In another embodiment, the other reference identifier may be a high or highest density (as defined above) reference identified within the same block of text as the citation.

In another embodiment, a piece of content is prioritized when multiple citations in a block of text point to that piece of content. In one embodiment, if a claim rejection cites to a reference identifier and separately cites to another piece of content, and if the reference identifier is contained in a number of pieces of content, the piece of content that is explicitly cited to is prioritized. In another embodiment, a piece of content that is closest to the explicitly cited drawing figure, in terms of layout, ordinal numbering, or the like, is prioritized. For example, if a claim rejection cites to paragraph 22 and also cites to reference identifier 18, where reference identifier 18 is contained in paragraphs 1, 20, 23, 44, and 50-200, then paragraph 23 is prioritized as paragraph 22 was cited in the same rejection, and paragraph 23 is closest to paragraph 22. Similarly, if FIGS. 1-15 depict reference identifier 18, but FIG. 3 is associated with paragraph 22 due to a large number of reference identifiers in common and/or an explicit reference in paragraph 22 to FIG. 3 (or an explicit reference in FIG. 3 to paragraph 22), FIG. 3 may be prioritized.

In another embodiment, a piece of content is prioritized when it contains or is associated with content that contains claim terms, terms used in attorney or examiner argument, search terms used by an examiner, or the like. In this way, the user is presented with paragraphs more likely to be relevant to the issues at hand.

In another embodiment, a piece of content is prioritized when it can be determined that the destination includes an example. Often, written description elements and claim terms are easier to understand in the context of an example. Accordingly, paragraphs that include the text “e.g.”, “for example”, etc., may be prioritized. Patent families (e.g. patents that claim priority to a common parent application, or which share substantial portions of their disclosure, at least one inventor, and a filing date) provide additional sources of information that can be used to prioritize content. For example, in a related application, if a particular piece of content (e.g. paragraph or drawing figure) was cited to, and if a rejection in the instant application cites to a reference identifier that occurs in some of the same pieces of content, then these pieces of content are prioritized. In general, any of the types of prioritization methods discussed above may be applied using comparable pieces of data from the prosecution history or other patents in the same family.

Once a piece of content has been selected for display in the definition window, in one embodiment instances of the highest density reference identifier are highlighted in the underlying content and the selected content. In another embodiment, there may be other reference identifiers near the mouse pointer (i.e. reference identifiers that did not have the greatest density) that also appear in the selected content. In one embodiment, one or more of the other reference identifiers are highlighted, in the underlying content (the content that contains the citation) and/or in the selected content. In this way, the user is enabled to quickly understand what the reference identifiers mean as he or she reads the patent.

In one embodiment, different highlight colors or shades are used when multiple reference identifiers are highlighted in the underlying block of text/drawing figure and the selected content. For example, if reference identifiers 12 and 18 both appear in the underlying block of text/drawing figure and the selected content, each instance of reference identifier 12 may be highlighted in purple, both in the block of text and the selected content, while each instance of reference identifier 18 may be highlighted in red, both in the block of text and the selected content. In one embodiment, as the mouse pointer moves, the shading (or any other attribute) of the highlight changes with the density (as defined above) of the reference identifier. For example, the shade of red may become darker as the density of reference identifier increases, or lighter as it decreases.

The definition window may be populated as the user browses a document or a popup. “Mouse pointer” can be any kind of pointer created by any kind of pointing device.

Additional Popup Highlighting

In one embodiment, when a citation is contained in the rejection of a claim, and when the citation is to a block of text, additional pieces of information within the popup are highlighted. For example, a practitioner may be interested to know search terms the examiner used when searching for references. These search terms may be extracted from the prosecution history. The practitioner may also be interested in seeing claim terms from the instant rejection, or where words and phrases used in the examiner's argument are located in the cited text. Thus, in one embodiment, citations located in a claim rejection may trigger a popup that highlights, in addition other citations, examiner search terms, claim terms, and/or words and phrases used in the examiner's argument portion of the instant rejection.

Double Patenting Rejections

Other types of rejections, such as double patenting rejections, may warrant additional processing to augment the content displayed in the corresponding popup. Double patenting rejections typically include two lists of claims. In one embodiment, hovering over one of the claims in the double patenting rejection triggers a popup containing the corresponding claim. In one embodiment, claims from the cited application are compared against the instant claims to identify potential differences, such as words unique to one claim-set or the other and/or words unique to one claim or the other. In one embodiment, words that appear in one claim but not the other and/or words that appear in one claim-set but not the other are highlighted in the popup.

For example, if claims 1, 2, 3 and 5 of the instant application are rejected over claims 22-25 of a related application, and it is determined that claim 1 of the instant application most closely matches claim 22 (e.g. using a Levenshtein distance or other string comparison algorithm), hovering over the “1” in “Claims 1, 2, 3 and 5” triggers a popup displaying the text of claims 1 and 22 side-by-side, where terms that only exist in one claim but not the other are highlighted.

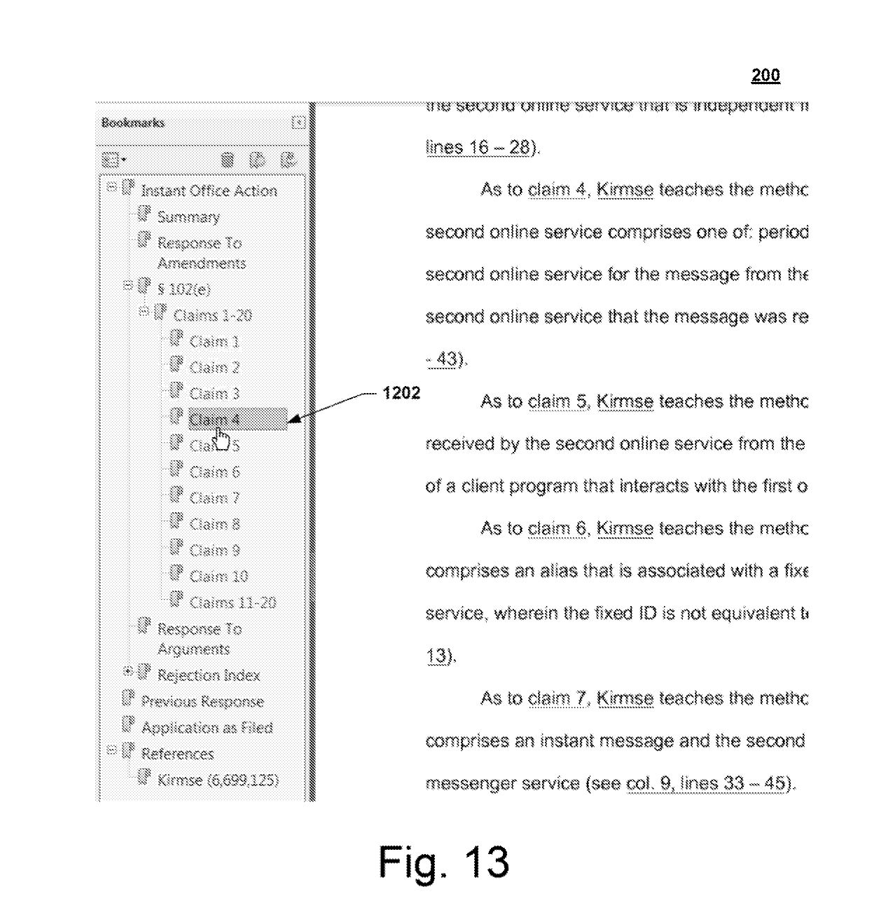

The content contained within popup 202 may itself be analyzed for citations, with links being generated therefrom. FIG. 3 depicts a cascading popup 304 containing figure 13 triggered by activating link 108 (“col. 6 lines 1-20”) followed by activating link 302 (reference identifier “12”). In one embodiment, citations are identified within popup content 202 using the same techniques as were applied to the underlying document. However, content contained in a popup may also be analyzed with a different set of rules, choosing to identify more or fewer citations, and whether to add additional highlights, data, or other information, than if the same content were analyzed as part of an underlying document. One factor in determining what citations to identify in a popup and what additional highlights, data, or other information to add is the context of the citation, such as the text surrounding the citation. For example, the type of rejection a claim citation is contained within may determine what citations are identified in the popup, as well as other highlights or data that enhance understanding of the documents. Other factors include the citation type, e.g. layout based vs. logical, and a popup cascade depth (defined as the number of ancestor popups a popup has). Thus, a user is further enabled to hover over citations contained within popup 202, causing popup 304 to appear. Citations may additionally be identified in popup 304, with links generated therefrom. Popups can continue to cascade in this manner to an arbitrary depth.

One advantage of the cascading popup embodiment for understanding interconnected documents is discovering cited content without drawing the eye any further away than necessary from the underlying document or intervening popups. Thus, the original link 108, which was used to begin the initial inquiry, is in view or a quick mouse gesture away (by dismissing the popups or increasing their transparency or making them invisible temporarily). The user does not need to re-orient themselves once they've understood the content of a citation, as is the case when opening documents in a new window or viewing them side-by-side. This advantage is also felt at any layer in the cascading popup—each time a user hovers over a link to understand a citation, the content that prompted the curiosity remains where it was and is easily accessible.

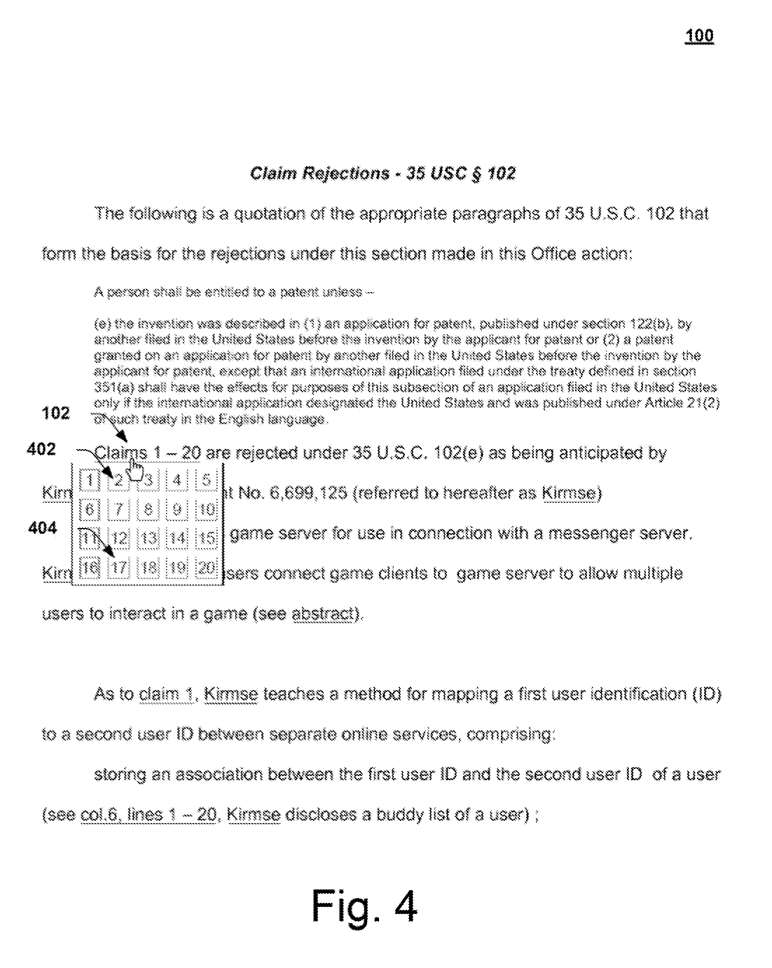

In general, when a popup is discussed throughout this application, a cascading popup is also contemplated. It is also understood that a multi-popup (discussed below in relation to FIG. 4) can be part of a cascade of popups, the only difference being the number of potential destinations of the citation.

In one embodiment, citations contain reference identifiers, or are themselves reference identifiers. For example, link 302 represents the citation “12”, which has been interpreted to be reference identifier 12. When the reference identifier stands alone as a citation, destinations are determined by finding other instances of the reference identifier throughout the document. Any piece of content—such as a drawing figure, paragraph, or other block of text—that contains the reference identifier is displayed. For example, Reference identifier 12 appears twice throughout the drawing figures, both times in figure 13. As such, hovering over reference identifier 12 in popup 202 causes popup 304, which contains figure 13, to be displayed.

In one embodiment, instances of the reference identifier are highlighted in the popup content. Continuing the example, both instances of reference identifier 12 in FIG. 13 are highlighted (i.e. highlights 306 and 308). In embodiments where the citation includes a reference identifier in addition to other citation data, such as “figure 13: 18”, the reference identifier isn't necessary to select “figure 13” for display, as “figure 13” is sufficient to make this determination, but “18” is still used to highlight instances of “18” in the popup content. In one embodiment, the “18” in the citation is also highlighted during the hover-over (e.g. “figure 13: 18” becomes “figure 13: 18” when the citation is hovered-over), so the user sees the connection between the reference identifier in the citation and the instances of the reference identifier in the popup. If more than one reference identifier exists in a citation, such as “figure 13: 17 and 18”, then all reference identifiers may be highlighted, in the popup content and/or the citation itself, all in the same color or each with its own color. In one embodiment, the reference identifier closest to the mouse pointer may be highlighted with a darker shade, bolding, or some other emphasis, both in the citation and in the popup content.

Other information contained in a citation may also be highlighted in the popup. For example, logical citations, such as to claims, numbered paragraphs, or any other identifier that is displayed in the destination document, is in one embodiment highlighted in the popup.

In another embodiment, additional reference identifiers may be determined to be of interest to the user, even though they are not contained in the hovered-over citation. User interest in a reference identifier may be gauged based on proximity to the hovered-over citation—physical proximity in the source content (the underlying document or, for a cascading popup, the popup that contains the citation), conceptual proximity, proximity based on shared digits in the reference identifier, and the like.

In one embodiment, a reference identifier is physically proximate if it occurs on the same line of text as the hovered-over link. In another embodiment, an additional reference identifier is physically proximate if it is one or more subsequent reference identifiers, reading top to bottom and right to left—even if it occurs on a different line of text.

In one embodiment, a reference identifier is conceptually proximate if its description is textually or semantically similar to the description of the hovered over link. For example, “clients 12” and “clients 20” both refer to clients, and as such reference identifiers 12 and 20 are conceptually proximate.

In one embodiment, proximity based on shared digits is determined by identifying shared least significant digits. For example, 102 and 202 share two least significant digits (“0” and “2”), and as such commonly are associated by shared digits. In one embodiment, 102 and 202 are considered more proximate based on shared digits than 102 and 112—which only share a single least significant digit (“2”).

Once additional reference identifiers are determined, and it is determined that the cited content contains instances of the additional reference identifiers, the instances of the additional reference identifiers are highlighted in the popup content. In one embodiment, the additional RIs are distinguished from the highlight of the hovered-over citation in color, texture, shade, or the like. In one embodiment, the additional reference identifiers in the underlying content (in addition to instances in the cited content) are themselves highlighted in response to hovering over the citation.

For example, if reference identifier 12 is hovered over, the reference identifier 18 (“Messenger server 18”) may also be of interest, as it is on the same line of text as reference identifier 12. An instance of this additional reference identifier is determined to exist on the cited content (figure 13). Thus, upon hovering over reference identifier 12, popup 304 is displayed with highlights 306 and 308 identifying instances of reference identifier 12 in a first color. Additionally, reference identifier 18 in popup 304 is highlighted in a second color. The reference identifier 18 in the text block (“Messenger server 18”) may optionally be highlighted in the second color.

Embodiments in accordance with the present disclosure may provide significant advantages to anyone reading or drafting interconnected documents, such as patents and related documents. Consider page 100 containing a citation to Kirmse 6:1-20. By utilizing the above-described cascading popups, the user is immediately able to evaluate the argument citing to Kirmse 6:1-20. The user does not have to parse the citation, e.g. read and identify that it is column 6, lines 1-20 of “Kirmse” that is being cited to, scroll up the rejection to find Kirmse's patent or publication number, navigate to a patent download website, download the Kirmse reference as a file, open the Kirmse reference, print the document, and locate 6:1-20. If the citation included any logical citations, such as paragraph numbers or reference identifiers, the user would additionally have to scan one or more pages to find them. Thus, large amounts of time, frustration, and potential error are saved by cascading popups, thereby enabling the user to address the problem at hand—determining the correctness of the rejection.

Another advantage is that, with the popup to Kirmse 6:1-20 open, the user may, in one embodiment, hover over citations contained in the popup to further his or her understanding of the Kirmse reference. For example, Kirmse 6:1-20 may cite to messenger server (MS) 18, but MS may not be described well enough to know with confidence what it means. Thus, one embodiment in accordance with the present disclosure enables the user to hover over MS 18 to view other portions of the Kirmse reference that also discuss element 18. The Kirmse reference may include drawing figures that contain different perspectives, levels of detail, or other use cases associated with reference element 18. The Kirmse reference may also describe reference element 18 in one or more other portions of the written description. Thus, in one embodiment, a multi-popup may be generated in response to hovering over reference element 18, wherein the multi-popup includes a list of links to drawing figures that depict reference element 18. Similarly, the multi-popup may include a list of paragraphs or other text ranges that reference element 18. The user is thereby enabled to hover over one or more of these links, each of which displays a popup containing content relevant to reference element 18, to gain a more complete understanding of reference element 18, Kirmse 6:1-20, and the rejection.

FIG. 4 depicts a “multi-popup” containing links to each of claims 1-20, triggered by activating link 102 (“Claims 1-20”). Links 402 (claims 2) and 404 (claim 17) represent links to claim 2 and claim 17, respectively. A multi-popup is defined as a popup that contains a plurality of hover-overable links, each to one of the plurality of destinations defined in the citation. Each link may indicate or otherwise describe the particular destination it represents. For example, it may contain a figure number, paragraph number, page number, or any other type of identifying information. Links may also contain an icon, image, thumbnail, or the like.

In one embodiment, links 402 and 404 point to the most recent claim-set on file at the USPTO. In another embodiment, the claims linked to are the claims as filed, optionally supplanted by a preliminary amendment. However, intervening claim sets, such as from previous amendments, may also be linked to.

“Multiple destination” citations are herein defined to be citations that contain more than one destination, where each destination has a single location (e.g. a definition) in the cited document. For example, “Claims 1-20” is a multiple destination citation, as it points to twenty different single locations. “Non-definitional” citations, as defined above, are a citation to a single part, concept, or entity that often has more than one instance throughout the destination document. The “12” in “Client 12” (when there are multiple instances of RI 12 throughout the document) is an example of a non-definitional citation. Multiple destination citations and non-definitional citations both trigger the display of a multi-popup.

“Multiple non-definitional” citations contain more than one non-definitional citation, and are represented with two levels of multi-popup—the first level containing one link for each non-definitional citation (e.g. “12”, “13”, and “14” in a citation “figure 13: 12-14”), and the second level containing links to other instances of the reference identifier. Continuing the example, if reference identifier “12” appears in figures 3, 8, 9, and 13, hovering over the “12” in the first level multi-popup would display a second level multi-popup with links to figures “3”, “8”, “9”, and “13”).

Links contained in a multi-popup may be organized. In one embodiment, links are displayed in a grid, arranged in the order they are found in the citation. In another embodiment, links are ordered numerically/alphabetically. In another embodiment, multi-popup links are arranged hierarchically, or in a tree that may be expanded or collapsed.

Whether displayed as a grid, hierarchy, tree, or the like, a multi-popup may group links that have something in common. For example, if a reference identifier appears in three drawing figures and two paragraphs of the written description, the links to the three drawing figures may be grouped together while the links to the two paragraphs may be grouped together. Links may be grouped in many ways: color coding (e.g. links to drawing figures appear blue, links to text appear red), appearing in separate multi-popups (e.g. links to drawing figures appear in one multi-popup, links to text appear in another multi-popup), or the like.

If a citation references too many locations to practically display in the multi-popup, the multi-popup may enable scrolling to reveal additional links. In another embodiment, a prioritization algorithm may be applied to determine which links to display first, and/or in what order. Prioritization algorithms as described above with regard to FIG. 2, to determine which piece of content to display in the definition window are, in one embodiment, also used to order links appearing in a multi-popup.

One instance in which multi-popup links are displayed in a hierarchy is a multi-popup pointing to a plurality of claims. In one embodiment, links are displayed in an expandable tree. When displaying links to claims in a hierarchy or tree, independent claims are at the highest (closest to root) level, with other links being indented proportional to their depth of claim dependency from an independent claim. Other types of links may be displayed in a hierarchy, including links to members of a patent family.

When displaying links to claims in a multi-popup, information about each claim may be represented by highlighting, bolding, underlining, using a larger link (font or box), or the like. For example, independent claims may be bolded while dependent claims are not. Claims may be colored based on their status. For example, links to claims that are original (i.e. not amended since the application was filed) may be colored green, while amended claims may be colored purple, while withdrawn claims may be colored grey. In this way, practitioners may gather at a glance significant information about a claim-set.

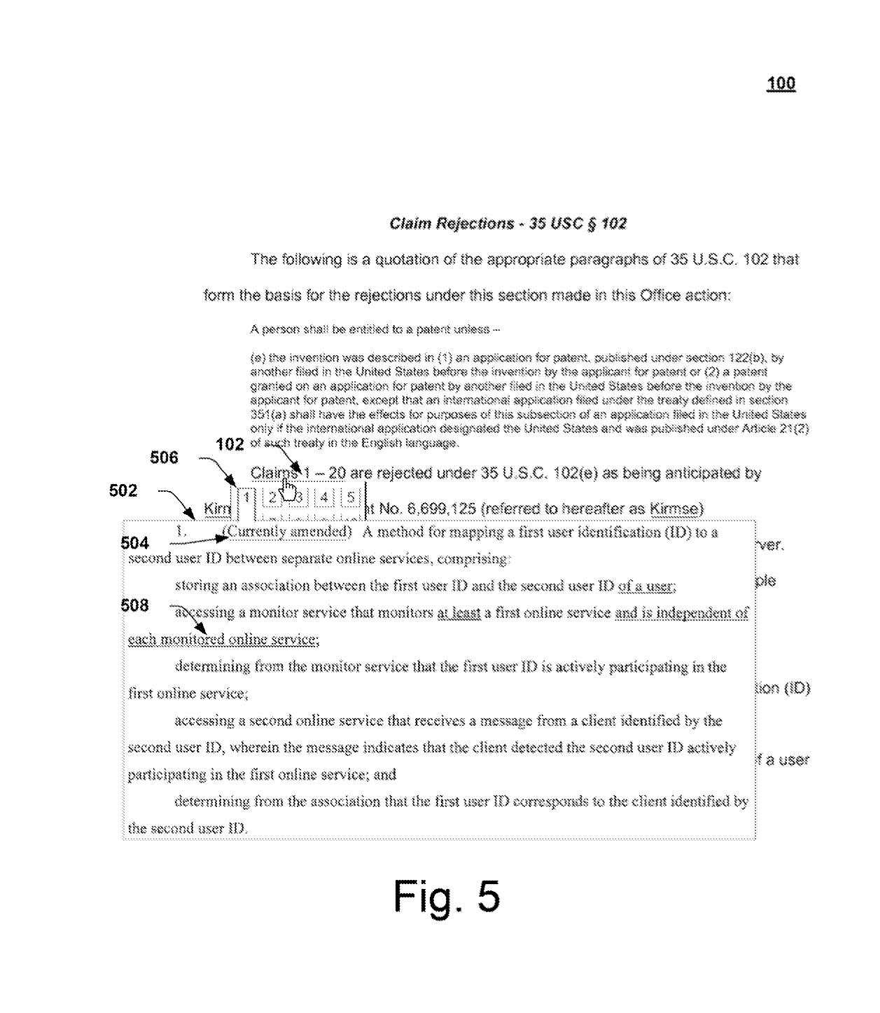

Multi-popups may have a default link that is triggered when the multi-popup is displayed. FIG. 5 depicts the multi-popup and a popup 502 containing claim 1, both triggered by activating the “Claims 1-20” link 102. However, in another embodiment, there is no default popup displayed, in which case user input must be received before one of the links is activated. For example, a user activating link 506 would display popup 502. In one embodiment, the content of the popup 502 is cropped from the actual claim-set document—as if the popup were a window into the cited to document.

In one embodiment, a link contained on a multi-popup may be activated by a hot-key corresponding to the location in the multi-popup grid. For example, a user may press “1” to activate the first link, “2” to activate the second link, etc.

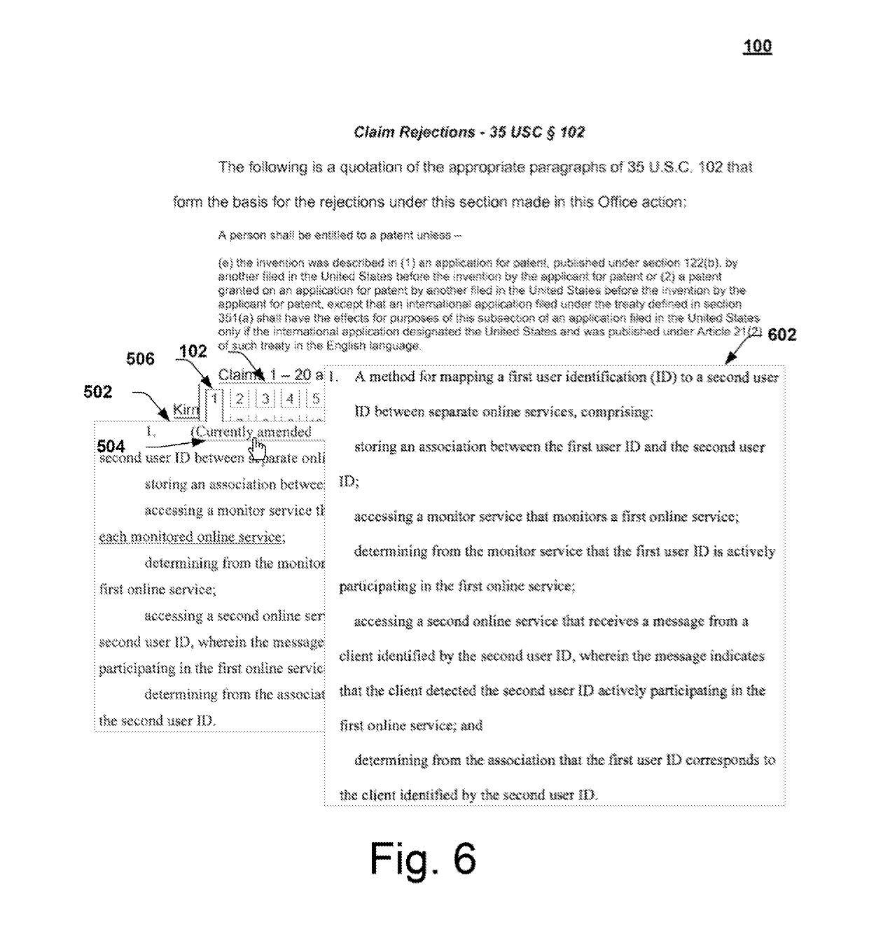

In one embodiment, a claim status “e.g. (Currently amended)” is identified as a citation and is the basis for link 504. As discussed below, hovering over link 504 will cause another level of popup to be displayed that contains a previous version of claim 1. If the previous version of claim 1 also includes a claim status, hovering over it will trigger another popup (see FIG. 6), such that versions of the claim may be recursively traversed back to the original. In this way, a user is able to seamlessly navigate a claim's history in the context of the rejection. Similarly, any other claim status can be recognized as a citation linking to a previous version of a claim—e.g. “Previously presented”, “Withdrawn”, “Canceled”, and the like.

In one embodiment, the user may hover over claim amendments to view one or more of practitioner argument, rejection, support in the specification, or other relevant content associated with the claim amendment. In one embodiment, hovering over the claim amendment displays a multi-popup containing links to one or more of these pieces of relevant content. In another embodiment, the one or more pieces of relevant information are displayed in the same popup, or in multiple non-overlapping popups that appear concurrently. In one embodiment, multiple non-overlapping popups appear in a horizontal row, each independently scrollable, such that a user is enabled to view each relevant piece of content side-by-side.

In one embodiment, hovering over claim amendment 508 (“and is independent of each monitored online service”) would display, in a new popup (which could be a child of a multi-popup, if multiple pieces of relevant content are available), the portion of the co-filed remarks section that discusses claim 1. In one embodiment a sub-portion of the co-filed claim 1 remarks are selected for display based on a search of the remarks for the amendment text, thereby bringing to the user's immediate attention the most relevant portion of the remarks.

Similarly, if the claim at issue was rejected in a previous office action (and preferably, when applicable, in the office action immediately preceding the amendment), the new popup could display a portion of the rejection of that claim. In one embodiment, a sub-portion of the rejection is selected for display, specifically the sub-portion of the rejection pertaining to the element the amendment is contained within, adjacent to, or otherwise associated with. For example, hovering over amendment 508 would display the rejection of the element “accessing a monitor service that monitors a first online service” (i.e. the element as previously filed that is). In one embodiment the relevant portion of the rejection of claim 1 is identified with a combination of layout analysis and text comparison, e.g. identifying the rejection of claim 1, then identifying the first paragraph of the rejection containing the associated element.

Furthermore, in one embodiment, support in the written description may be found for the amendment by searching for text that matches, or approximately matches, the text of the amendment. While searching for support of an amendment is discussed here, the same technique applies generally to one or more claim elements, or a claim as a whole. In one embodiment, potential sources of support are identified by, for each paragraph (or other block of text) in the written description, determining whether that paragraph contains a significant portion (at least 20%, but perhaps as much as 85% or 100%) of the words in the amendment. In one embodiment, common pronouns and patentese are excluded from the search, e.g. “said”, “one or more of the group containing”, “in one embodiment”, and the like. In another embodiment, differences in plurality and tense are ignored. Paragraphs (or other blocks of text) that contain more matching words/noun phrases are given greater weight.

In another embodiment, the words of the amendment and the words of each paragraph are first parsed into noun phrases (e.g. “monitored online service”), and the same comparison is performed, except that noun phrases are searched for instead of the words that constitute the noun phrases. In another embodiment, noun phrases are searched for in addition to searching for each word in the amendment. In one embodiment, matched noun phrases give a paragraph greater weight than if the words constituting the noun phrase were separately matched.

In one embodiment, another factor in determining if a paragraph provides support for the amendment is what percentage of words/noun phrases appear in the order they appear in the claim. The greater the percentage of words that are found in order, the greater the weight given to that paragraph.

In another embodiment, greater weight is given to paragraphs also contain words/noun phrases in the claim element that contains, is adjacent to, or otherwise associated with the amendment. For example, “accessing a monitor service that monitors a first online service” is the claim element that amendment 508 was added to. A paragraph containing the noun phrase “a monitor service” and “a first online service”, all else being equal, is given greater weight. Similarly, a paragraph is given greater weight if surrounding paragraphs contain words/noun phrases found in the associated claim element. In another embodiment, a paragraph is given greater weight if surrounding paragraphs contain support for claim elements that surround the associated claim element.

In another embodiment, particularly if the amendment/element(s)/claim for which support is sought is long, the search may be extended to include multiple paragraphs in the specification. The algorithm discussed above may be applied to groups of two or more paragraphs. In one embodiment, groups of paragraphs are determined systematically—trying all groups of two paragraphs, three paragraphs, and/or the like.

In another embodiment, groups of paragraphs are selected based on association with a particular drawing figure. Often, patents are drafted such that each drawing figure is described by a series of contiguous paragraphs in a written description section. In one embodiment, a series of paragraphs associated with a drawing figure is identified by searching for text that introduces a drawing figure, such as “FIG. 6 discusses”, “in FIG. 6”, and the like. Typically, this text appears at the beginning of a paragraph. The series of paragraphs describing FIG. 6 is presumed to continue until text introducing another figure is encountered, or the end of the detailed description is encountered.

In another embodiment, a group of paragraphs is determined to be associated with a particular drawing figure based on the reference identifiers included in each paragraph. Each drawing figure is analyzed to determine which reference identifiers are contained within it. Each paragraph is also analyzed to determine which reference identifiers are contained within it. Each paragraph is associated with the drawing figure it shares the most reference identifiers with. In one embodiment, if a paragraph doesn't include any reference identifiers, it is associated with the drawing that is associated with the preceding paragraph. Then, a group of paragraphs is determined by finding a contiguous series of patents associated with same drawing figure.

As with any other popup discussed herein, any citations contained in practitioner argument, rejection, or support in the specification may be the basis for additional cascading popups. Additionally, while popups containing practitioner argument, rejections, and support in the specification are discussed in the context of a claim amendment, these same techniques are applicable any time content is displayed in a popup.

Visualizing Claim Terms

In one embodiment, hovering over a claim term triggers popup(s) to portions of the written description and/or drawing figures that describe the claim term. For example, noun phrases in a claim may be associated with the same or similar (differences in tense, plurality, etc. allowed) noun phrases in the written description, from which paragraphs (or other blocks of text) of the written description may be identified. Reference identifiers associated with the noun phrase in the written description may then be used to identify drawing figures associated with the claim term.

In another embodiment, Verbs in a claim are searched for in the text of a flow chart box (differences in tense, plurality, etc. allowed). For instance, “accessing”, which begins the element that amendment 508 was applied to, may be found at or near the beginning of text contained in a flow chart box. Once a flow chart box is identified, a reference identifier associated with it (either found within the box or at the other end of a lead line nearest to or touching the box) can be used to identify paragraphs associated with the box.

When multiple paragraphs and drawing figures associated with a claim term are identified, particular drawing figures and paragraphs will be chosen for display based on one or more of the priority algorithms discussed above with regard to FIG. 2. Priority may also be given based on how many times the hovered-over claim term is found in a text block.

In one embodiment, selected drawing figures and paragraphs are displayed in popups near the hovered-over claim term. In one embodiment, a multi-popup containing selected drawing figures appears above the claim term (y-axis), while a multi-popup containing selected paragraphs appears below the claim term (y-axis). However, drawing figures and claim terms may appear grouped in the same multi-popup, as described above with regard to FIG. 4. In another embodiment, the drawing figure and paragraph with the highest priority are chosen for display simultaneously, and can be arranged above and below the hovered-over claim term, or side-by-side. In one embodiment, reference identifiers associated with the hovered-over claim term are highlighted in the displayed paragraphs and drawing figures.

Patent claim-sets typically include independent and dependent claims. Often, terms introduced in an independent claim are narrowed in the dependent claim. For example, claim 1 includes the term “a first online service”, while claim 2 (which depends on claim 1) recites “the first online service comprises an online game service”. In one embodiment, claim understanding is enhanced by viewing these narrowed definitions in the context of the independent claim (or any other base claim).

For example, if claim 3 (which depends on claim 1) recited “the first online service comprises an online dating service”, hovering over the term “a first online service” in claim 1 triggers a popup indicating that claim 2 defines the first online service as an online game service, and claim 3 defines the first online service as an online dating service.

In one embodiment, these narrowing definitions are displayed in a tree defined by the hierarchy of the claim-set. This allows further sub-definitions to be understood in context. For example, if claim 4 depends on claim 3, and claim 4 recites “the online dating service comprises a mobile online dating service”, then a user can quickly understand the first online service can be a game service or a dating service, and that the dating service can be an online dating service.

In one embodiment, claim language that indicates a narrowing definition includes “XXX comprises a YYY”, “XXX is a YYY”, “XXX contains YYY”, “XXX having a YYY”, and the like.

In one embodiment, in a dependent claim, text copied from the base claim to further narrow an element is less interesting than the new definition ascribed to the element. For example, if claim 2 recites “the first online service comprises an online game service”, “the first online service comprises” merely introduces the element being narrowed, and as such is less interesting than “an online game service”. So, in one embodiment, text in a dependent claim that further narrows an element, e.g. text that comprises an element and that appears in a base claim, is marked up to minimize its importance. For example, it may be greyed out.

In another embodiment, claim preambles, in either dependent or independent claims, are greyed out.

In one embodiment claim language is made more readable by adding syntax highlighting (e.g. color coding) to common claim constructs, such as negative limitations, if/then statements, means plus language, “each one of . . . ” “a plurality of . . . ”, etc.

In one embodiment, claim readability is enhanced by identifying words unique to each claim. This can speed understanding of a claim, such as when a dependent claim has a significant amount of text that is not unique, but rather copied from the independent claim. Once identified, these words may be bolded or inserted into the margin near each claim, or presented in a popup upon hovering over the claim number. In one embodiment, for a given claim, words are identified as unique if they don't exist in any claim that doesn't depend from the given claim. This is because dependent claims may further define the claim, but it is still interesting to know which claim a term is first introduced in.

FIG. 6 depicts a popup containing a previous version of claim 1 triggered by activating the “Claims 1-20” link 102, the “1” link 506, and the “Currently Amended” link 504.

In another embodiment, a scrollable claim amendment history is presented in popup 502. In one embodiment, scrolling to the left displays the previous version of a claim in popup 502, while scrolling to the right displays the subsequent version of a claim in popup 502, although other directions of scrolling are similarly contemplated. In one embodiment, claim versions are extracted from a file history, from an initial application, preliminary amendments, amendments, and the like.

In one embodiment history-scrollable popup 502 includes a prosecution timeline. The timeline indicates where in the chronology of amendments the claim currently displayed in popup 502 was found. In one embodiment, other versions of a claim are indicated by hash-marks on the timeline, and a user may view these other versions in a cascading popup by hovering over the hash mark, or click on the hash-mark to view that version of the claim in popup 502 (in addition to or as an alternative to horizontally scrolling through versions of the claim).

It is common for practitioners to review previous versions of a claim, and he or she may do this from the context of a previous office action. In this case, there may be subsequently filed versions of the claim. The claim timeline would thus indicate not just versions of the claim filed previous to the current claim, but that subsequent versions of the claim are available for inspection. Thus clicking on the timeline (or scrolling, e.g. to the right) would cause a version of the claim more recent than the instant version to be displayed in popup 502.

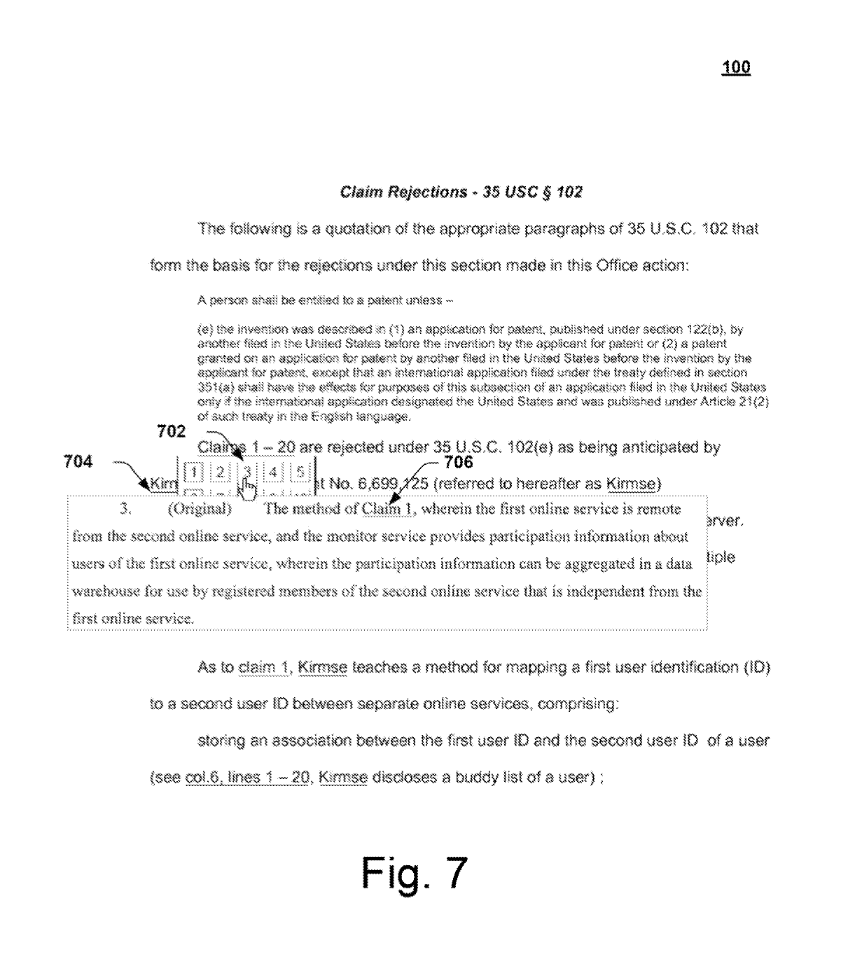

FIG. 7 depicts a popup 704 containing claim 3 triggered by activating the “Claims 1-20” link and the “3” link 702. By hovering over links successively, a user is able to rapidly sift through claims (or whatever is cited to) looking for relevant information. The status of claim 3 is “Original”, and as such it does not link to another version of the claim. Claim 3 depends on claim 1, as indicated by the citation to “Claim 1”. Link 706 may be hovered over to popup the content of claim 1.

FIG. 8 depicts a popup 802 containing claim 1, from which claim 3 depends, triggered by activating the “Claims 1-20” link, the “3” link, and the “Claim 1” link 706. While a user reading that claim 3 depends on claim 1 could have navigated back to the multi-popup and hovered over the “1” link to display claim 1, this back-tracking would likely distract his or her train of thought. One of the benefits of the claimed embodiments is providing quick and immediate access to cited information, at the point of citation, thus allowing the reader to concentrate on the content itself, not how to locate and display it.

FIG. 9 depicts a popup 902 containing a previously entered version of claim 1 triggered by activating the “Claims 1-20” link, the “3” link, the (obscured) “Claim 1” link, and the “Currently amended” link 904.

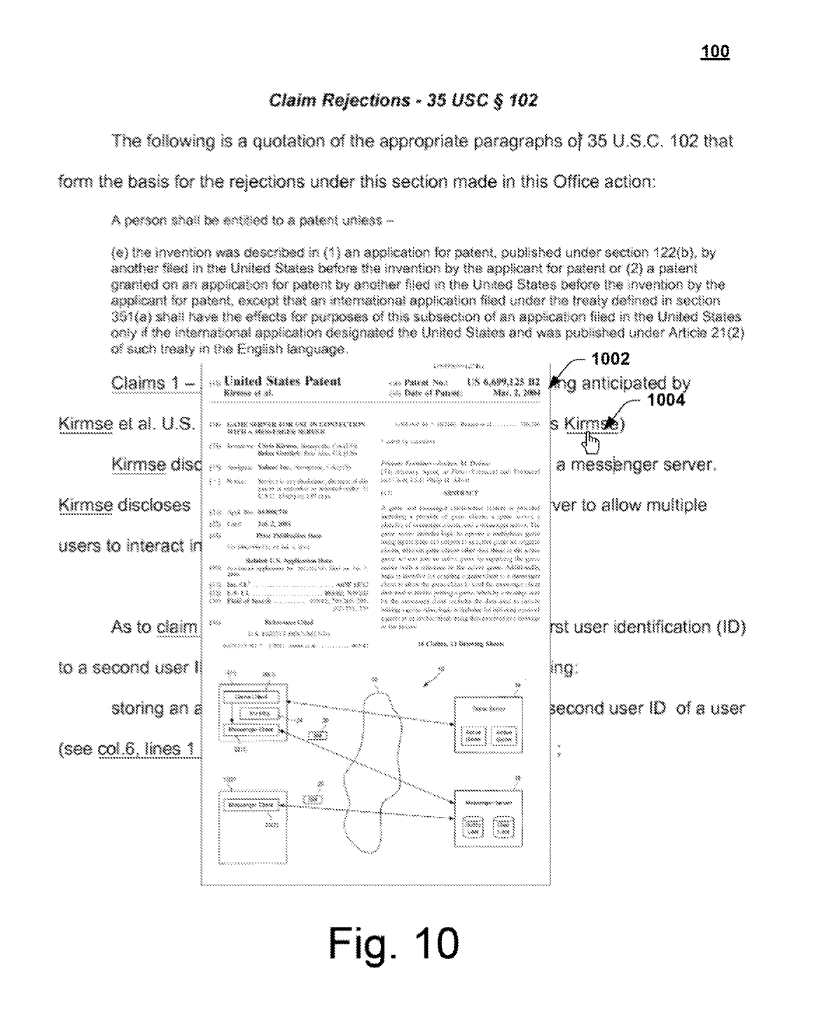

FIG. 10 depicts a popup 1002 containing the cover page of the Kirmse reference, triggered by activating the “Kirmse” link 1004. In one embodiment, clicking on link 1004 opens a new window with the Kirmse patent as the “underlying document”.

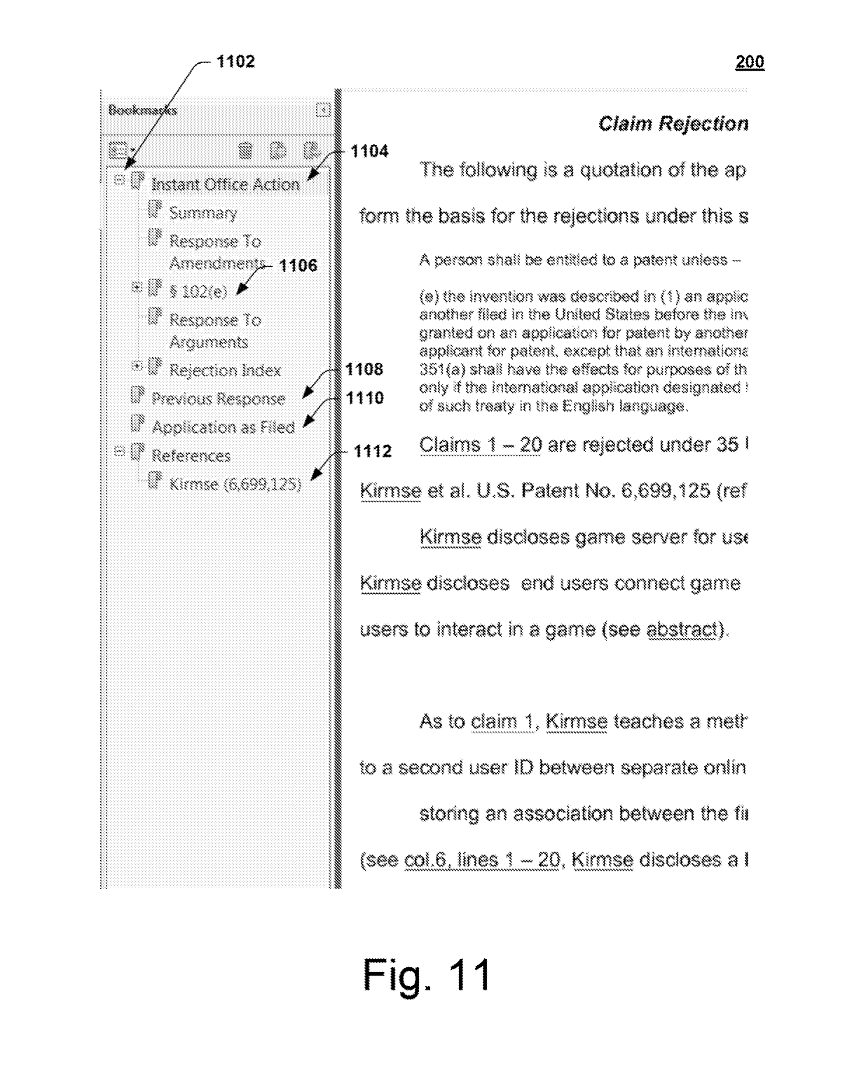

FIG. 11 depicts a user interface 200 containing a link hierarchy 1102 representing documents extracted from a file wrapper and references (e.g. Kirmse) cited in the instant office action. While depicted in FIG. 11 in a bookmarks bar, this same information may be embedded in the cover page of an office action, an email, a website, a popup, or the like. Link 1104 points to the instant office action, which has child links to different sections of the office action—the summary, response to arguments, 102(e) rejections 1106, and a rejection index. Link 1108 points to the previous response (i.e. the previous amendment filed for the instant patent application), link 1110 points to the application as filed, and link 1112 points to the Kirmse reference, which is the only reference cited in the instant office action.

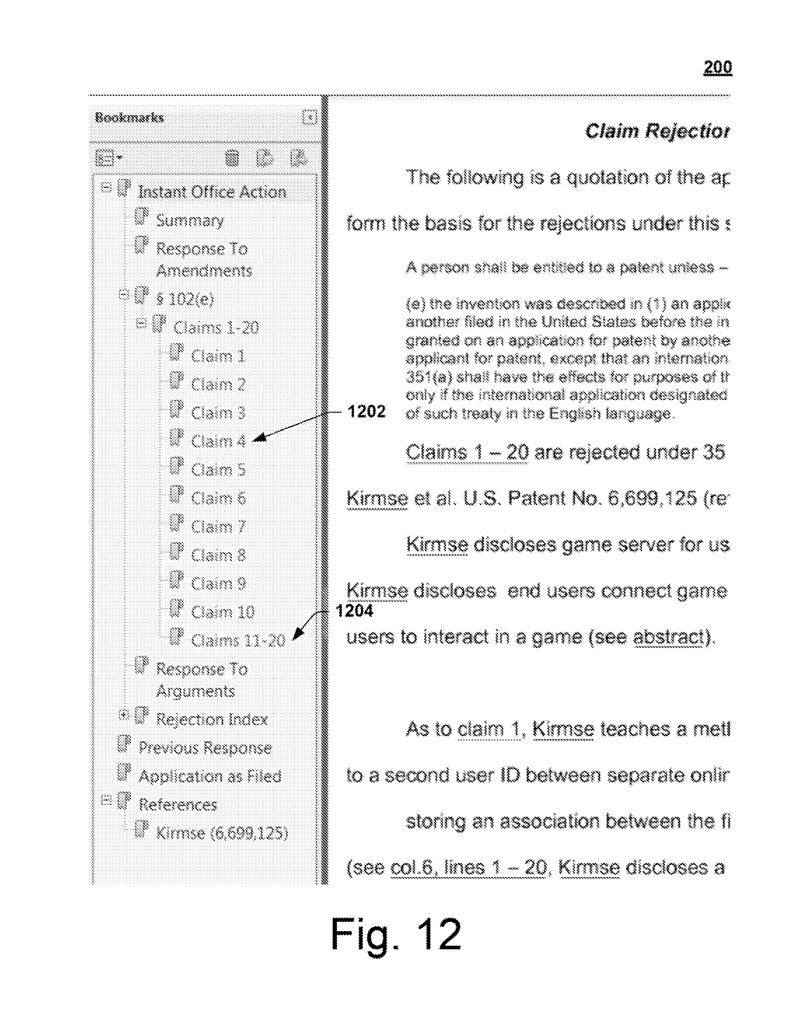

FIG. 12 depicts user interface 200 containing the link hierarchy 1102 with an expanded 102(e) rejection node 1106 that contains links to each 35 USC 102(e) rejection. This hierarchy represents the rejections as they are identified in the office action, not the claim-set dependency tree. For example, link 1202 points to the rejection of claim 4, while link 1204 points to the rejection of claims 11-20.

FIG. 13 depicts the rejection of claim 4, triggered by activating the “Claim 4” link 1202 in the link hierarchy 1102. In one embodiment, the rejection of claim 4 is aligned at the top of the page. In another embodiment, the rejection of claim 4 is highlighted. In another embodiment, the rejection of claim 4 is initially highlighted to draw the user's eye, but the highlight fades away after a few seconds.

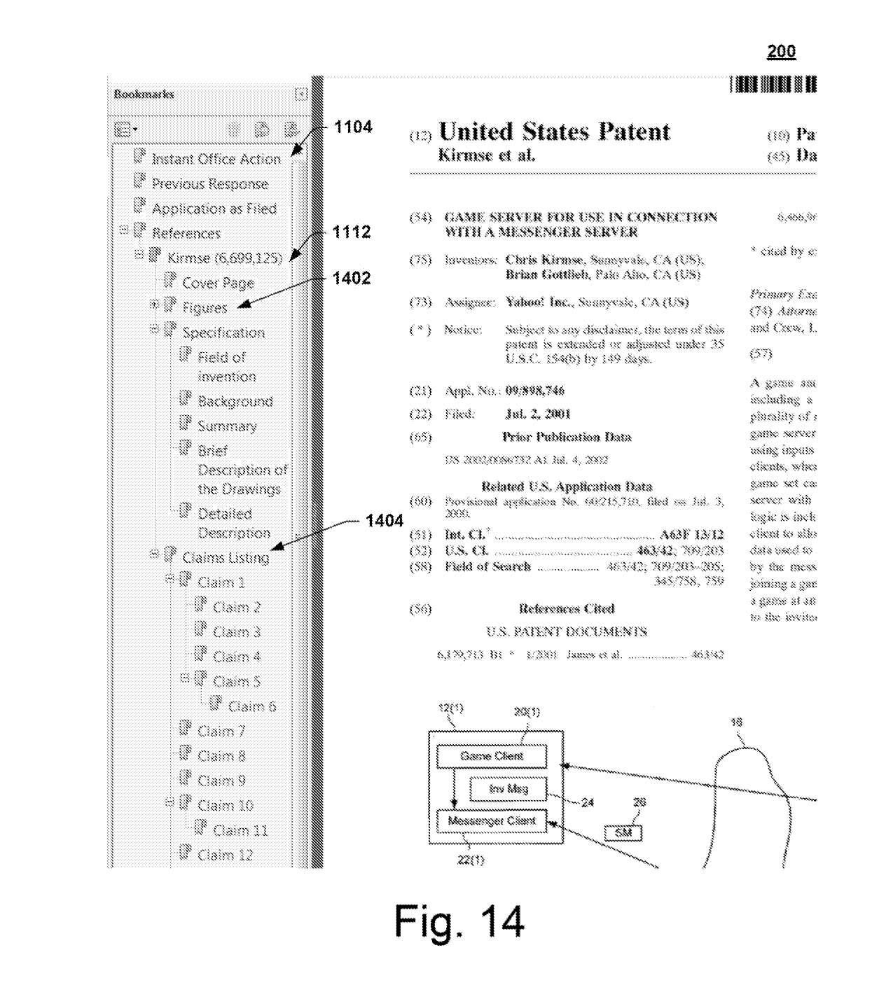

FIG. 14 depicts the link hierarchy as viewed from the Kirmse reference. In one embodiment the Kirmse reference is being displayed because a user clicked on link 1112—although any other means of navigating to the Kirmse reference, such as clicking on link 106 of FIG. 1, is similarly contemplated. In one embodiment, the link hierarchy changes based on which document is being displayed. For example, link 1104 to the “Instant Office Action” is no longer expanded (or expandable) to view the sections of the office action, such as rejection node 1106, because the Kirmse document is now highlighted, while links to sections of the Kirmse document are available, such as link 1402 to the Figures of the Kirmse reference, or link 1404 to the Claims listing of the Kirmse reference. This way, a user is enabled to navigate between documents by clicking on document level links, which remain on display regardless of which document is active. The user is then able to navigate within the currently open document.

In one embodiment, the “Claims Listing” (link 1404) depicts the claims of the Kirmse reference in a hierarchy based on the dependency hierarchy.

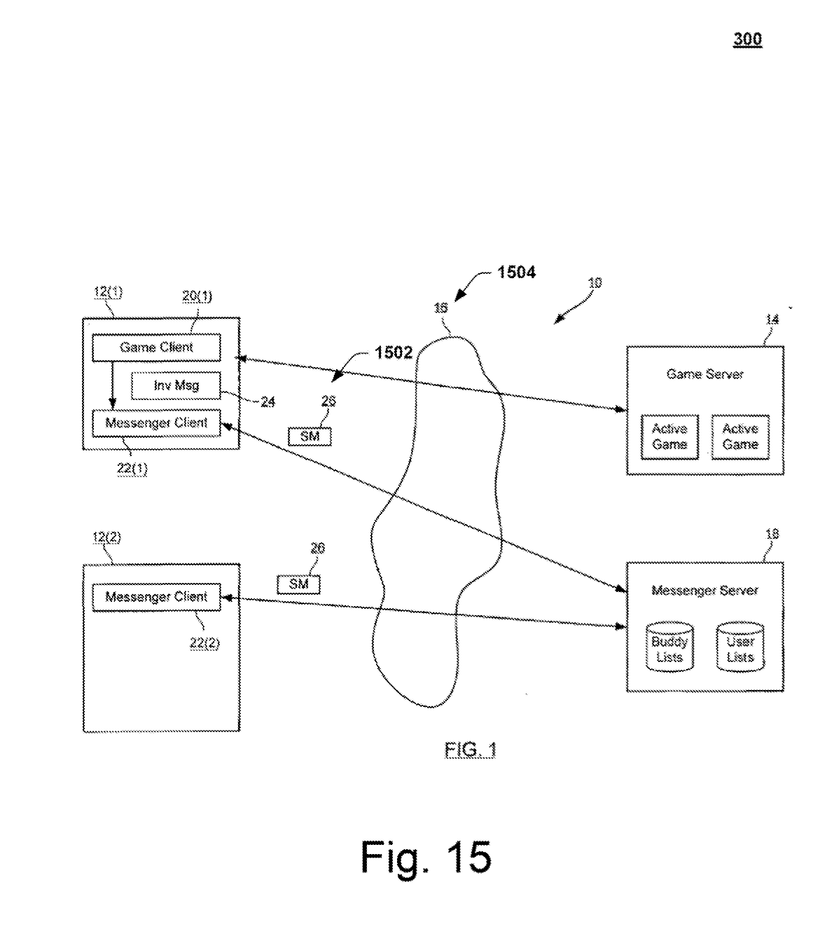

FIG. 15 depicts a drawing FIG. 300, including reference identifier links. In one embodiment this drawing figure appears in the drawing figures section of a patent or patent publication. In another embodiment, as seen in FIG. 3, drawing FIG. 300 appears in a popup. However drawing FIG. 300 comes to be displayed, a user is enabled to hover over reference characters to trigger a popup or a multi-popup to related pieces of content, such as by hovering over link 1502 to reference identifier 26 or link 1504 to reference identifier 16.

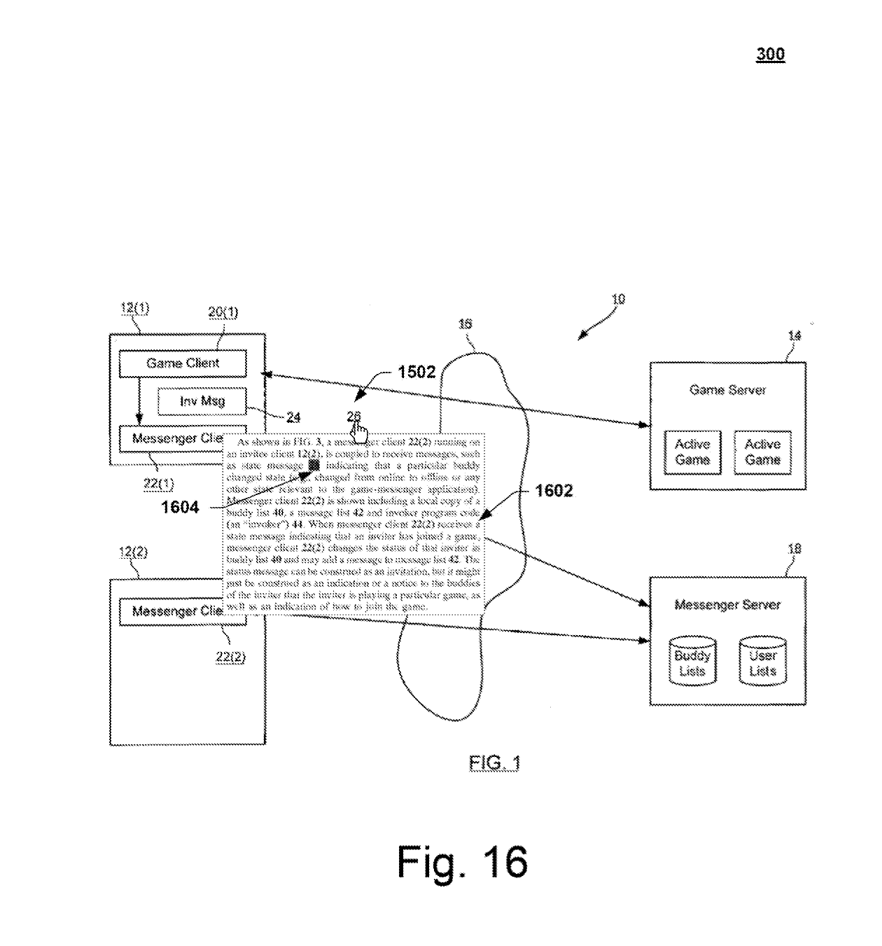

FIG. 16 depicts a popup 1602 containing a paragraph of text that contains reference identifier 26, triggered by activating the reference identifier 26 link 1502. The instances of reference identifier 26 (in this example just a single instance) are drawing to the user's attention with highlight 1604.

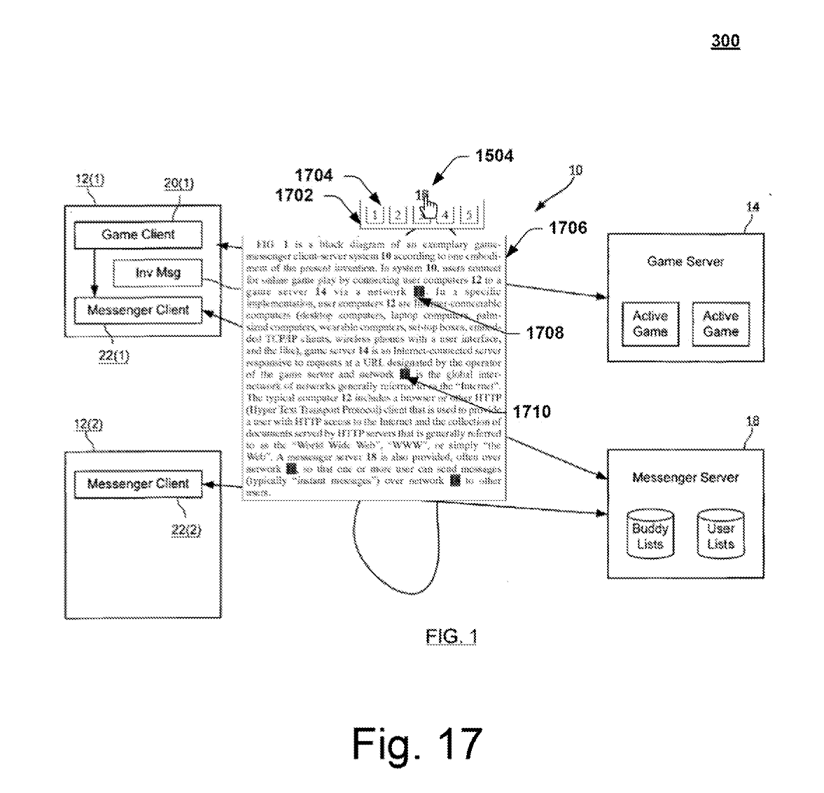

FIG. 17 depicts a multi-popup 1702 to five portions of text that contain reference identifier 16, where one of the five popups 1704 has been chosen for display in popup 1706, and where, as reference identifier 16 is the citation link 1504 is based on, each instance of reference identifier 16 is highlighted in popup 1706 (e.g. highlights 1708 and 1710).

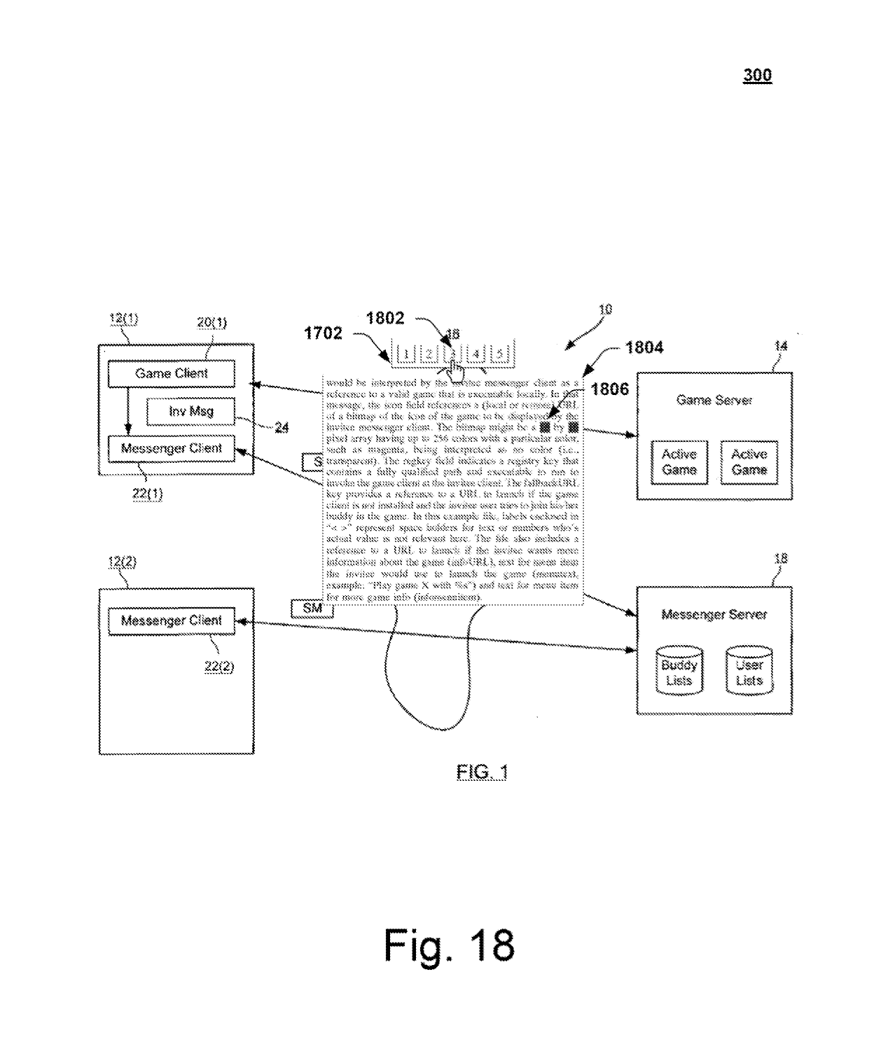

FIG. 18 depicts link 1802 (popup “3”) having been selected by hover-over, triggering the display of popup 1804 containing a paragraph of text containing reference identifier 16. As discussed in relation to FIG. 17, instances of reference identifier 16 are highlighted, e.g. highlight 1806, because the citation the multi-popup was based on includes reference identifier 16.

FIG. 19 depicts a portion of a written description 400. In one embodiment, highlighted text 1902 is displayed as a result of clicking (or otherwise activating) link 1802. In one embodiment, the highlighted text 1902 is the text that was contained in popup 1804. In one embodiment, information associated with link 1802 is further highlighted within highlighted text 1902. For example, link 1802 was contained in the multi-popup triggered by hovering over link 1504, which was based on a citation to reference identifier 16. Thus, instances of reference identifier 16 (e.g. link 1904) are highlighted in highlighted text 1902.

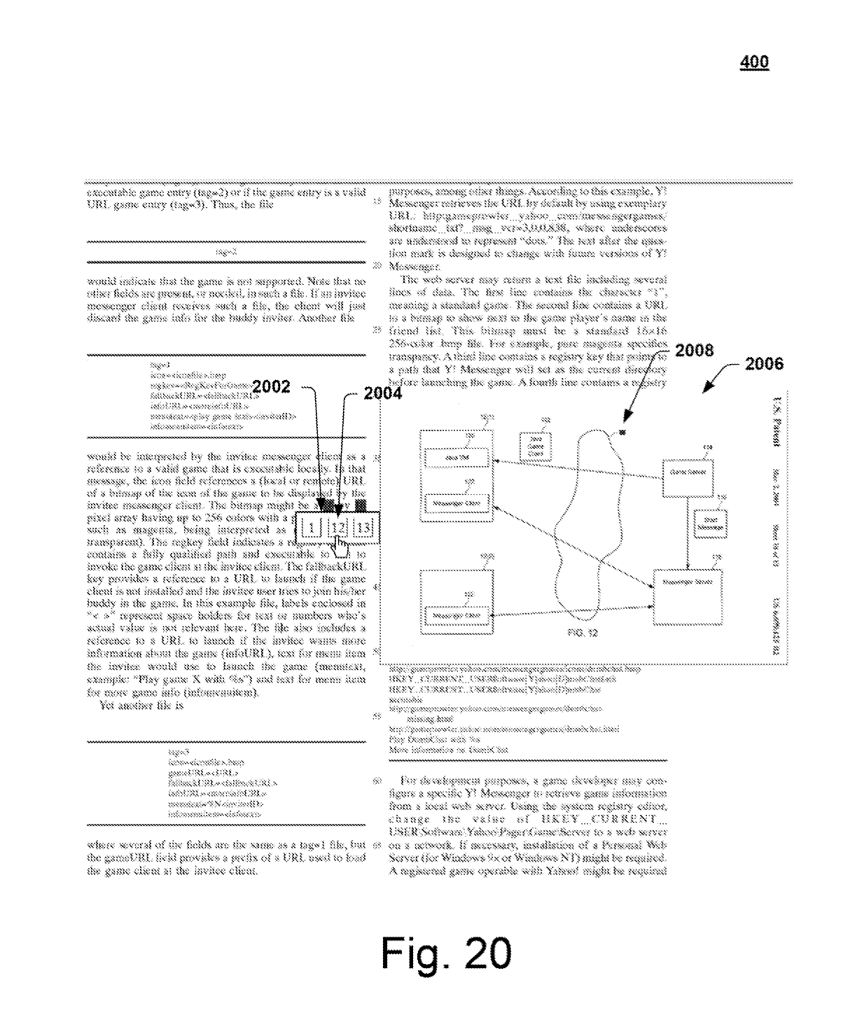

FIG. 20 depicts a multi-popup 2002 linking to three figures (1, 12, and 13) that contain reference identifier 16, as well as a popup 2006 containing FIG. 12 triggered by activating link 2004 (“12”). As can be seen, links to logical portions of the document (e.g. numbered portions), such as claims, drawing figures, and the like, enable the links contained in multi-popup 2002, such as link 2004, to indicate which drawing figure they point to. In one embodiment, the instances of the citation (or portion of the citation) underlying the multi-popup are highlighted in popup 2006. For example, the underlying citation is to reference identifier 16, and so each instance (link 2008) of reference identifier 16 is highlighted in popup 2006.

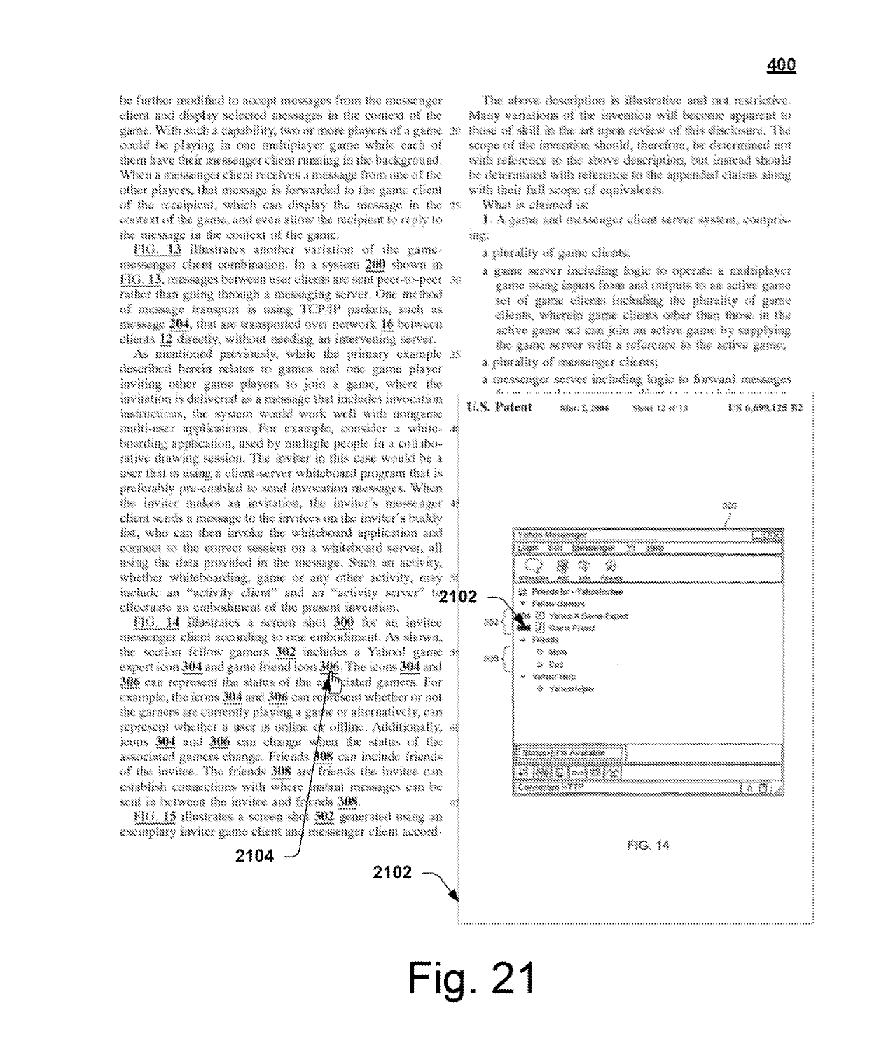

FIG. 21 depicts a popup 2102 containing FIG. 14 that highlights 2102 reference-index 306 and is triggered by activating the “306” link 2104.

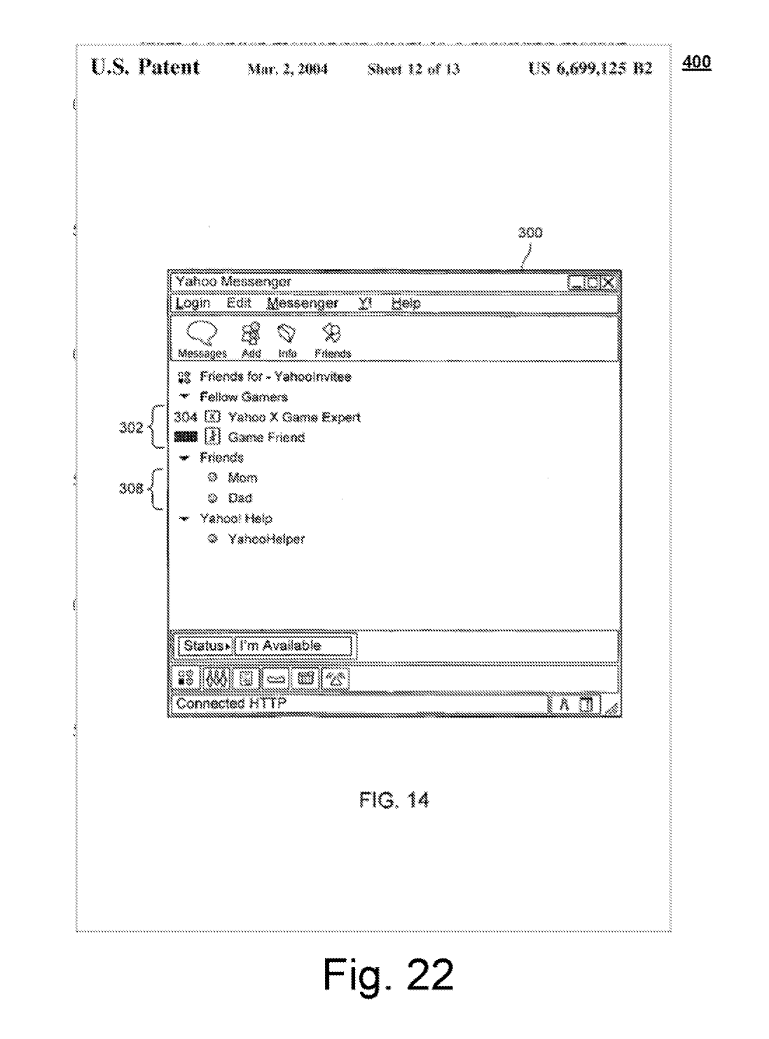

FIG. 22 depicts a close-up of the popup 2102 containing FIG. 14.

Navigating a Patent Family

More than the instant application, information from related documents, such as other members of the same patent family, is relevant. In one embodiment, a list of applications in the same family is inserted into or otherwise associated with the office action.

In another embodiment, this same information could be displayed in a web page, an email, a piece of stand-alone software, or the like. In one embodiment, the user is presented with a list of attorney docket numbers to identify the family members (or publication number, patent number, filing number). Any other bibliographic information about the family members may be included in the list, including first named inventor, drafting attorney, law firm, and the like.

In one embodiment, primary drawing figures and first independent claims of each family member, both as filed and as currently entered, are presented to the user in the list. In one embodiment, these claims and figures are presented inline, each providing the basis for one or more cascading popups into their corresponding file wrapper. In this way, a practitioner is enabled to quickly view the state of the patent family.

In another embodiment, claims from family members are analyzed for differences. In one embodiment, a list of words or phrases uniquely used in each application is generated for presentation to the user. In this way, a practitioner can quickly understand what each member of the family is directed to.

In one embodiment, a list of allowed claims from other applications in the same family are inserted or otherwise associated with the office action. For example, a cascading popup or a multi-popup may be employed to view the allowed claims, similar to those depicted in FIGS. 4-9. In another embodiment, an analysis of the allowed claims is performed to identify claim terms added (or removed) in the final amendment before allowance—as this may be a hint to what subject matter made the claims allowable. Another analysis of claim terms may be performed to identify claims in the instant application having similar scope to the allowed claims. In one embodiment, a note (possibly presented as a multi-popup) to the practitioner may be inserted near the similarly scoped claims, including the text of the allowed claim, and the list of the claim terms added (or removed) in the final amendment to the allowed claim. In one embodiment, a link to the Examiner's reason for allowing the allowed claim is extracted from the file wrapper of the allowed application and added to the note to the practitioner.

In one embodiment, when an application is one of a family of patents/applications, the specifications of each application are analyzed to identify terms and phrases unique to each application in the family. In one embodiment, at the top of the specification, a multi-popup may enable quick reference to each use of these unique terms throughout the specification.

Other Interpretattions of a Reference

Specific types of documents within a prosecution history may be more easily understood if enhanced by adding information. For example, an instant office action is written by a patent examiner with regard to claims in a particular patent application. It may be beneficial for the practitioner to view how references used in the instant office action (or any equivalent documents, e.g. other patents, domestic or foreign, in the same family as the reference) have been used before by other examiners to reject claims in other applications. Moreover, it may be beneficial for the practitioner to see how other practitioners responded to these rejections. The other examiner's rejection and the other practitioner's response may help the practitioner understand the reference more quickly. Similarly, the practitioner may also benefit from reading what the examiner has already written about any common portions of the disclosure shared between applications in the same family (or any other application).

However, as examiners are likely to have different interpretations of the same reference, it is also beneficial for the practitioner to view how the instant examiner in particular has used the references to reject other applications (and the corresponding responses to these uses by other practitioners). Similarly, when the instant application is part of a family, it is beneficial for a practitioner to see how references cited in the instant office action were used to reject other applications in the same family (and the corresponding responses to these rejections). This may prevent a situation where different attorneys working on applications in the same family characterize a reference or claim term differently. Moreover, whenever the instant office action cites to a particular paragraph, figure, reference identifier, or any other portion of a reference, it is beneficial for the practitioner to view rejections over these same citations (or citations to related content, such as a citation to a figure that corresponds to a paragraph cited in the instant office action) by any other examiner, and the corresponding responses to those rejections. Similarly, it would also be of benefit to the practitioner to view uses of the same reference, particularly to the same citation, made in an earlier office action of the instant application. Thus, in one embodiment, a collection of file wrappers, patents, and pre-grant publications are analyzed to identify other patent applications in which references used in the instant office action were relied upon to reject another application. At the same time it is noted whether the examiner making the rejection is the instant examiner, whether the application being rejected is in the same family as the instant application, and whether particular citations were used in making out the rejection that match or are related to citations used in the instant rejections. The identified other applications are processed to extract the related rejections and responses for viewing by the practitioner.

Any or all of the above factors may be combined to increase the likelihood that viewing a previous rejection (and corresponding response) would benefit a practitioner. For example, instances where the same examiner working on an application in the same family used the same citation of the same reference may be identified. In general, the more a rejection has in common with a rejection in the instant office action, the more likely the rejection and corresponding response will be relevant to the practitioner.

Also, if the practitioner works in a firm, it would be beneficial to know what attorneys also at the firm have worked on applications in the same family, particularly previous office actions in the instant application, so the other attorney could be consulted over email or in person to quickly convey relevant information about the case.

In one embodiment, related rejections and corresponding responses may be embedded into or otherwise associated with the office action, such as in the cover page. In another embodiment, this information may be added to in the context of the relevant rejection in the instant office action. For example, hovering over a rejection of a claim may trigger a cascading popup that includes a related rejection and/or corresponding response from another application. If multiple related rejections are identified, a multi-popup may be employed to enable quick review of each related rejection, in the context of the instant rejection. In either case, the cascading/multi popup provides easy access to review the actual rejections and responses extracted from the other applications.

File Wrapper Analysis

Statistics Derived from File Wrappers

In one embodiment, a corpus of file wrappers may be downloaded and processed. Statistics about individual attorneys and firms may be extracted, such as by noting how often an office action response leads to allowance, how often an argument, amendment, or combination or argument and amendment lead to overcoming a rejection, and the like. These statistics may be normalized by art unit, classification (e.g. International Patent Classification), examiner, client, and the like.

Potential Licensing Opportunities in File Wrappers

File wrappers may also be analyzed to find patents and publications used as references in a 102 or 103 rejection in which the application failed to issue. This could suggest a potential licensing opportunity to the assignee of the cited patent, as the owner of the application that failed to issue might be developing a product the rejected claims were based on. Different levels of confidence may be ascribed to such patents. If the rejection was a 102, it is more likely to indicate a licensing opportunity. Also, if the application was abandoned soon after the reference was asserted, it is more likely to indicate a licensing opportunity. In one embodiment, a user may search for rejections made over particular portions (e.g. figures, paragraphs, text ranges) of a particular patent/publication. Thus, if an entity is interested in licensing a particular piece of novelty claimed in a patent, and the user knows which paragraphs and drawing figures describe that piece of novelty, the user can search for rejections over these paragraphs and drawing figures, as the claims rejected over them are more likely to be associated with a product that potentially infringes on the particular piece of novelty.

In another embodiment, potential licensing opportunities are identified by finding paragraphs (and associated figures) that contain elements recited in a set of allowed claims. In one embodiment, the technique of finding support in the specification as described above in relation to FIG. 5 is used to identify the paragraphs and related figures. Then, the corpus of file wrappers are analyzed to find all rejections over the identified paragraphs and associated figures. There rejections may to a claim that is part of a patent that is assigned to a potential licensee.

Finding Potential Prior Art

In one embodiment, file wrappers are also analyzed to help in prior art searching. When a potential piece of prior art is otherwise identified, it would be useful to know if it has been cited recently by an examiner—as the application it was cited against may also be prior art. Thus one embodiment searchers for all applications that have been rejected over the potential piece of prior art. In another embodiment, the search may be limited to applications that were rejected over a given portion (e.g. set of figures, paragraphs, text ranges, etc.) of the potential piece of prior art

Common Responses

In another embodiment, the file wrappers are searched for common rejections and responses thereto. For example, if a particular 101 rejection becomes common, as evidenced by a new piece of boilerplate used in 101 rejections, the embodiment may search for responses to the rejection that have proven persuasive, as evidenced by the rejection being withdrawn in a subsequent office action. In one embodiment, statistics about the efficacy of practitioners (as described above) may be used to identify responses written by particularly capable individuals. Thus, in one embodiment, if the particular rejection is identified in an office action, an alert is generated for the user indicating that a common rejection was found, and that one or more successful responses are available to view. In one embodiment a template response based on the proven persuasive responses and the specifics of the rejected claim is generated and inserted into an office action response.

In one embodiment, the alert is inserted into a popup anchored by the identified common rejection. In another embodiment, the alert may be inserted into the cover page of an office action, or in a status box of a docketing system.

Claim-Based Notes

One challenge encountered when drafting an office action response is recalling conclusions a practitioner has made about cited information as it relates to a patent claim element. It is common for each element of a claim to be rejected over a reference, but sometimes the granularity of rejection is a phrase or even an individual word of the claim. Moreover, each rejection may cite to as many as ten distinct portions (or more) of one or more references. Practitioners often make hand-written notes to store their thoughts and conclusions, often in the margin next to the cited passage as it is being read. Distributing notes across many pages of many documents makes integrating these thoughts difficult. Even if a practitioner is able to remember or cobble together all relevant conclusions while drafting the instant office action response, reviewing attorneys, clients, Examiners, or other interested parties will start from scratch.

Thus, another embodiment of the disclosed invention includes a method of receiving notes entered by a practitioner in association with a particular claim, or even a particular claim element. For example, if a practitioner is investigating whether the claim element “a soda can” was properly rejected by [0004] of the MrSoda reference, the practitioner may navigate to [0004], read it, and determine it does teach “a soda can”. The user is then enabled to indicate that the rejection of the “a soda can” element was proper. In one embodiment, the user navigates to [0004] of the MrSoda reference by a popup, as described above with regard to FIGS. 1-10. The user indicates that the rejection is proper by pressing a hot-key while [0004] is open in the popup window. In this way, an indication that the claim element (“a soda can”) is properly rejected by [0004] of MrSoda can be seamlessly received. However, if MrSoda [0004] was not satisfactory to properly reject “a soda can”, the practitioner could indicate as much with a different hot key while [0004] was being displayed.

Additionally or alternatively, the user may enter a note about why [0004] does or does not teach or anticipate “a soda can”, so that he can later be reminded of the reason without re-investigating.

If the practitioner later notices that [0040] of the MrSoda reference does disclose the “soda can” reference, the practitioner may associate [0040] with the “soda can” element. For example, the practitioner highlight paragraph [0040], and then activate a context menu that lists the rejected claims, and which enables drilling down to semi-colon delimited elements, and finally to individuals words and phrases. An association can then be made between the content (e.g. [0040]) and any portion of the claim (entire claim, semi-colon delimited element, phrase, word, etc.). An association may indicate that the content anticipates the claim element, or that it does not anticipate the claim element, or that it is associated in some other way. The association may include a note written by the practitioner. For example, a practitioner may indicate that the “a soda can” element is properly rejected by [0040] of Mr. Soda, even though [0040] was not cited by the examiner. The practitioner may speculate that the examiner transposed digits in the rejection, intending [0040] but actually writing [0004]. In another embodiment, the practitioner may “drag n′ drop” a portion of a reference to the claim element it rejects.

In another embodiment, a user is enabled to associate notes with a portion of a claim, without also associating a portion of content.

In one embodiment, while reviewing the claims, the practitioner may review notes, indications that a cited reference does or does not teach a claim element, and/or text/drawing figures that have been associated with each claim element. In one embodiment, the practitioner may hover over claim elements in a marked up version of an office action, specification, previous response, or the like, to view notes associated with the claim elements. In another embodiment, user generated notes about a claim element may be another group of links available in a multi-popup associated with a claim element. In this way, the user can easily view text references, drawing figures, and user generated notes associated with each claim element or phrase.

This system of user created notes associated with claim elements has numerous advantages. User create notes may be imported into subsequent office actions, to the extent that claim elements between the office actions are the same. This could potentially save hours of time re-checking rejections that have previously been investigated. Moreover, reviewing attorneys and clients are enabled to review the notes produced by the drafting attorney.

Multi-Modal Document Editing

Multimodal documents, such as documents that contain text-based content and graphics-based content, are typically created with multiple different tools, such as a word processor and a drawing application. Often, content of a first mode, such as text-based content, is associated with content of a second mode, such as a drawing. For example, second mode content may be a repackaging of the first mode content. In these situations, drafting multimodal documents can be tedious, as the drafter manually creates content in one mode only to create similar content in another mode.

In one embodiment, a word processing functionality and a drawing figure functionality operate to identify, generate, and insert a drawing figure representation of a piece of text identified in a written description portion of a patent application. In one embodiment, a piece of text that is representable in a drawing figure portion of a multimodal document is identified. For example, the piece of text may include a reference identifier. In one embodiment the reference identifier is identified as it is typed into the word processing program.

In one embodiment, a graphical depiction of the reference identifier is generated and inserted into the drawing figure. In one embodiment the graphical depiction includes a lead line. In one embodiment the inserted graphical depiction is editable.

In another embodiment, the reference identifier is parsed to determine which drawing figure the corresponding graphical depiction is to be inserted into. In another embodiment, the reference identifier is parsed by stripping any parenthetical characters, then removing the right two characters. What remains is the drawing figure number used to identify the drawing figure the graphical depiction of the reference identifier is to be inserted into. For example, if reference identifier 2302(b) is detected, the figure number used is 23.

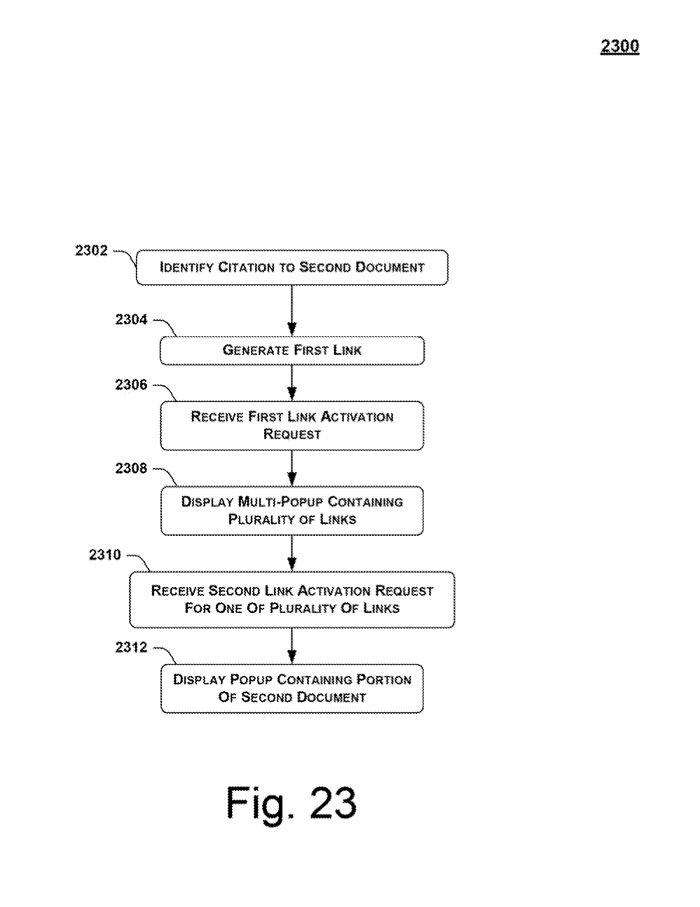

In one embodiment, if a drawing figure corresponding to the reference identifier does not exist, the drawing figure is created, inserting a “FIG. XX” description of the drawing figure based on the reference identifier, and then inserting the reference identifier. For example, if reference identifier 2302 is detected, and FIG. 23 does not yet exist, FIG. 23 is created with a “FIG. 23” description, and a graphical representation of 2302 is inserted into it.

In one embodiment, a descriptive element may be associated with the reference identifier. For example, if the specification includes the phrase “pop-top 2301 of can of soda 2302”, the “can of soda” is associated with 2302. Thus, in addition to inserting a graphical depiction of 2302 with a lead line, a database of drawing figures may be searched to find a depiction of a soda can, which can then be inserted into the appropriate drawing figure.

In one embodiment, an analysis of the written description may determine that a reference identifier is identified with a flow char. For example, if the text “flow char 2400” is included in the written description, “pop open the soda can 2406” may be interpreted as an element in flow chart 2400. In this case, the graphic depiction of reference identifier 2406 may include a flow chart box large that contains the text “pop open the soda can”, in addition to an underlined depiction of 2406. In another embodiment, the graphical depiction of 2406 is drawn outside of the flow chart box, but connected to the box with a lead line.

In one embodiment, a claim representable as a flow chart may be identified, where each claim element is identified as mapping to a box in the flow chart. In one embodiment, a user may invoke a functionality to generate a flow chart based on the claim by extracting each element of the claim, generating a box to fit each element of the claim, copying each element of the claim into the corresponding box, and inserting the boxes into a new drawing figure.

In one embodiment, arrows connecting the generated flow chart boxes are created, pointing from the box containing the first element of the claim to the box containing the last element of the claim. In one embodiment, a reference identifier is created and inserted or associated with a lead line with each box in the flow chart.

In one embodiment, a written description of the identified patent claim is generated and inserted into the written description portion of the application. In one embodiment, text from each claim element and the corresponding reference identifier (created for the corresponding drawing figure) is inserted into the written description.

In one embodiment, changes to any of the identified claims, the generated flow chart, or the generated written description are reflected in each other.

In one embodiment, a claim is identified as being representable by a flow chart based on the pre-amble. For example, means plus function claims, method claims, computer readable medium claims, and the like may indicate that a claim is representable by a flow chart. Another method of detecting whether a claim is representable by a flow chart is looking for claim elements that begin with verbs or gerunds, such as “popping” or “bicycling”.

Claim Editing

In one embodiment, support is added for claim editor enhancements, such as through a word processor plugin. When drafting an office action response, the plugin performs track changes. For example, text added to a claim is automatically underlined, text deleted from a claim is automatically struck-through or double square bracketed.

In another embodiment, claim status is automatically updated based on the state of a claim. For example, if a user edits a claim, the status may be changed from “previously presented” to “currently amended”. In one embodiment, based on knowledge from the file wrapper of when a claim was first canceled, a claim's status may be changed from “canceled” to “previously canceled” or “currently canceled”. In one embodiment, claim status (currently amended, previously presented, original . . . ) in the claim section is kept in sync with the claim's status in a remarks section, and in a conclusion section.

In another embodiment, claim text from the claims listing is kept in sync with corresponding claim test in the remarks section. In another embodiment, when a claim element is amended, propose making similar amendments to similar claim elements throughout the claim set, including dependent claims and base claims of the edited claim.

Claim fee estimates. When new claims are added, use knowledge from the file wrapper as to how many claims were filed, including how many independent claims, and alert the user if additional claims in the instant amendment will incur claim fees (and how much).

Auto-Insertion

While editing a response to an office action, enable a user to insert quotations, tables, drawing figures, chemical structures, and the like, from the application as filed, a cited reference, or an office action. In one embodiment, a user may insert the object by typing in a citation to it (e.g. ‘Table 2’) and activating a hot key. Additionally or alternatively, a context menu listing objects available for insertion may be activated and selected from, in which case upon pasting the object, a citation to the object is automatically inserted into the office action response.

Word Processor Settings

Word processor settings—when editing an office action response, ignore spell check for inventor names and terms used throughout the spec and references. Turn off auto-capitalization when editing claims.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is new and desired to be protected by Letters Patent of the United States is:

1. One or more computer-readable storage media encoding computer-executable instructions for executing on a computer system a computer process, the computer process comprising:
identifying, in a first document, a citation to a second document, wherein the citation includes an identifier that occurs more than once throughout the second document;
generating a first link proximate to the first citation;
receiving a first request to activate the first link;
in response to the first request, displaying a multi-popup containing a plurality of links, wherein each of the plurality of links points to a portion of the second document that contains the identifier;
receiving a second request to activate one of the plurality of links in the multi-popup; and
in response to the second request, displaying a second popup containing a portion of the second document associated with the activated one of the plurality of links.

2. The one or more computer-readable storage media of claim 1 wherein the computer process further comprises:
receiving a third request to dismiss the second popup;
in response to the third request, dismissing the second popup;
receiving a fourth request to activate a second one of the plurality of links; and
in response to the fourth request, displaying a third popup containing a portion of the second document associated with the activated second one of the plurality of links.

3. The one or more computer-readable storage media of claim 1 wherein the computer process further comprises:
identifying, in the portion of the second document associated with the activated one of the plurality of links, a citation to a second portion of the second document;
generating, in the first popup, a second link, wherein the second link is proximate to the second citation;
receiving a third request to activate the second link; and
in response to the second request, displaying a second popup containing the second portion of the second document.

4. The one or more computer-readable storage media of claim 1 wherein the computer process further comprises:
ordering the plurality of links based on the number of times the identifier appears in each of the portions of the second document.

5. The one or more computer-readable storage media of claim 1 wherein the computer process further comprises:
ordering the plurality of links by prioritizing links to portions of the second document that include one or more of:
a definition of an acronym associated with the identifier,
an indication the portion of the second document contains an example,

6. The one or more computer-readable storage media of claim 1 wherein the computer process further comprises:
ordering the plurality of links by prioritizing links to portions of the second document that include a second identifier that is also included in the citation.

7. The one or more computer-readable storage media of claim 1, wherein the first document includes an argument about a patent claim, wherein the computer process further comprises:
ordering the plurality of links by prioritizing links to portions of the second document that include one or more of: terms contained in the patent claim, terms used in the argument.

8. The one or more computer-readable storage media of claim 1, wherein the first document and the second document comprise source code, and wherein the first citation comprises a programming identifier, and wherein the portions of the second document comprise references to the programming identifier.

9. The one or more computer-readable storage media of claim 1, wherein the computer process further comprises:
grouping the plurality of links in the multi-popup based on a content type of each portion of the second document.

10. The one or more computer-readable storage media of claim 1, wherein the computer process further comprises:
grouping the plurality of links in the multi-popup based on a content type of each portion of the second document, wherein the possible content types include:
drawing figures, written description.

11. The one or more computer-readable storage media of claim 1, wherein each of the plurality of links in the multi-popup displays content identifying the linked to portion of the second document.

12. A method for understanding interconnected documents, comprising:
identifying, in a first document, a first citation to a first portion of a second document;
generating a first link proximate to the first citation;
receiving a first request to activate the first link;
in response to the first request, displaying a first popup containing the first portion of the second document;
identifying, in the first portion of the second document, a citation to a second portion of the second document;
generating, in the first popup, a second link, wherein the second link is proximate to the second citation;
receiving a second request to activate the second link; and
in response to the second request, displaying a second popup containing the second portion of the second document.

13. The method of claim 12, further comprising:
highlighting, in the first popup, an instance of a portion of the first citation.

14. The method of claim 12, wherein the first document is the second document.

15. The method of claim 12, further comprising:
identifying, in the first portion of the second document, a citation to a third portion of the second document;
generating, in the first popup, a third link, wherein the third link is proximate to the third citation;
receiving a third request to dismiss the second popup;
in response to receiving the third request, dismissing the second popup;
receiving a fourth request to activate the third link; and
in response to the third request, displaying a third popup containing the third portion of the second document.

16. The method of claim 12, wherein the first request and the second request are hover-overs, further comprising:
receiving a click to the second link;
in response to receiving the click to the second link, opening a window containing the second document; and
navigating within the second document to the second portion of the second document.

17. The method of claim 12, wherein the first link is color coded based on a document type of the second document.

18. A system, comprising:
one or more processing units; and
memory comprising instructions that when executed via at least one of the one or more processing units perform a method, comprising:
identifying, in a first document, a phrase referred to more than once in a second document;
generating a first link proximate to the phrase;
receiving a first request to activate the first link;
in response to the first request, displaying a multi-popup containing a plurality of links, wherein each of the plurality of links points to a portion of the second document that refers to the phrase;
receiving a second request to activate one of the plurality of links; and
in response to the second request, displaying a second popup containing a portion of the second document associated with the activated one of the plurality of links.

19. The system of claim 18, wherein the first document comprises a patent claim set, wherein the phrase identified comprises a patent claim element, wherein the second document comprises a written description of a patent, and wherein the portions of the second document referring to the patent claim term comprise support for the patent claim term, wherein identifying, in a first document, a phrase referred to more than once in a second document further comprises:
searching the written description for paragraphs of text that contain a defined percentage of words contained in the patent claim element.

20. The system of claim 19, wherein identifying, in a first document, a phrase referred to more than once in a second document further comprises:
identifying, in the paragraphs of text that contain a defined percentage of words contained in the patent claim element, one or more phrases associated with a reference identifier; and
identifying drawing figures that contain the one or more reference identifiers.
